(19) United States
(12) Patent Application Publication
(10) Pub. No.: US 2026/0093517 A1
(43) Pub. Date: Apr. 2, 2026

(54) COORDINATING DATA COLLECTORS OF MANAGED COMPUTING NETWORKS

(71) Applicant: Hewlett Packard Enterprise Development LP, Spring, TX (US)

(72) Inventors: Gowtam Chandra Karanth, Bangalore (IN); Shubha Krishna Shetti, Bangalore (IN); Ananya N. Ambli, Bangalore (IN)

(21) Appl. No.: 18/978,058

(22) Filed: Dec. 12, 2024

(30) Foreign Application Priority Data
Sep. 27, 2024 (IN) 202441073370

(51) Int. Cl. G06F 9/455

(52) U.S. Cl. CPC G06F 9/45558; G06F 2009/4557; G06F 2009/45591

(57) ABSTRACT

In certain implementations, a computer-implemented method includes receiving, by a computing device, registration information from a plurality of virtualization data collectors that are configured to collect first data from a first virtualization manager of a managed network for transmission to a data consumer service located in a cloud network. The virtualization data collectors are located in the managed network. The method further includes determining, by the computing device from among the plurality of virtualization data collectors, a particular virtualization data collector to transmit the first data to the data consumer service. The method further includes configuring, by the computing device, the particular virtualization data collector to transmit the first data to the data consumer service, and configuring, by the computing device, other virtualization data collectors in the plurality of virtualization data collectors to refrain from transmitting the first data to the data consumer service.

### BACKGROUND

Data and/or applications may be hosted on an on-premises network or on a cloud network. In some scenarios a cloud network may provide resources for managing a managed computing network. The managed computing network could be, for example, a so-called on-premises network. For example, the on-premises network could be a private network associated with a particular entity (e.g., company, university, government, etc.). As another example, the cloud network may be a public network that provides services for one or more entities and is accessible over a communication network, such as the internet. The on-premises network and the cloud network each may have computing nodes, such as a server, a cluster of servers, a storage array, a workstation, a storage system, a converged system, a hyperconverged system, or another suitable type of processing system.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example system for coordinating data collectors of a managed computing network, according to certain implementations;

FIG. 2 illustrates an example computer system on which a collector coordination engine may be run, according to certain implementations;

FIG. 3 illustrates an example signaling flow for coordinating data collectors of managed computing networks, according to certain implementations;

FIG. 4 illustrates an example system for coordinating data collectors of a managed computing network, according to certain implementations;

FIG. 5 illustrates example collector mapping table, according to certain implementations;

FIG. 6 illustrates an example method for coordinating data collectors of managed computing networks, according to certain implementations;

FIG. 7 illustrates an example method for coordinating data collectors of managed computing networks, according to certain implementations;

FIG. 8 illustrates an example method for coordinating data collectors of managed computing networks, according to certain implementations;

FIG. 9 illustrates an example method for data synchronization, according to certain implementations;

FIG. 10 illustrates an example method for handling a data collectors failover, according to certain implementations; and

FIG. 11 illustrates a block diagram of an example computing device, according to certain implementations

### DESCRIPTION

In modern computing environments, virtualization technology has become increasingly prevalent. Virtualization may allow multiple virtual machines to run on a single physical server, potentially providing more efficient use of hardware resources. To manage these virtualized environments, organizations may employ virtualization managers, such as VMWARE VCENTER as just one example. These virtualization managers also may be referred to as hypervisor managers or other suitable names.

Virtualization managers may oversee various aspects of the virtual infrastructure, such as the creation, configuration, and/or monitoring of virtual machines, as well as the management of underlying physical resources like servers, storage, and networking equipment. Virtualization managers may provide a centralized interface for administrators to control and monitor the virtualized environments. In some implementations, a virtualization manager may manage one or more clusters. Furthermore a given computing environment (e.g., an on-premises computing environment associated with an enterprise) may operate multiple virtualization managers.

As virtualized environments continue to grow in size and complexity, effective data collection and management become increasingly important for maintaining operational efficiency and supporting business objectives. These computing environments may generate significant amounts of data. For example, the virtualization managers may generate and/or otherwise obtain data about these computing environments, including inventory information about virtual machines, hosts, and clusters, as well as performance metrics related to central processing unit (CPU) usage, memory utilization, storage capacity and utilization, network traffic, as just a few examples.

In some scenarios, it may be desirable to provide this data to other entities for processing. For example, it may be desirable to provide this data, which is generated in a managed computing networks (e.g., an on-premises computing environment), to a cloud computing environment that runs various services for managing the managed computing environment. These cloud services for managing the managed computing network may collect and analyze the data for any of a number of purposes, such as capacity planning, performance optimization, troubleshooting, and facilitating compliance with service level agreements (SLAs).

One technique for providing this data to a data consumer service in a cloud computing network includes using one or more virtualization data collectors located at the managed computing network. These virtualization data collectors may collect data from the virtualization managers, and transmit the collected data to a data consumer service in the cloud computing network. These virtualization data collectors may be associated with different products or services deployed in a managed computing network, such as private cloud systems, disaster recovery solutions, and backup/recovery tools.

As just one example of a managed computing network with virtualization data collectors, the managed computing network may include multiple sets of resources, with each set including compute, network, and storage resources. Each set of resources may include a virtualization data collector that collects information from one or more virtualization managers and reports that information to a data consumer operating in the cloud network that is used to manage the managed computing network.

Managed computing networks may include multiple virtualization data collectors, many of which may collect similar (and possibly identical) data, and provide that data to the data consumer service in the cloud computing environment. For example, when multiple virtualization data collectors are connected to the same virtualization manager (e.g., vCenter), the multiple virtualization data collectors may collect and transmit duplicate data to the cloud (e.g., to the data consumer service operating in the cloud network). This duplicate transmission of data creates numerous inefficiencies, including both excessive and unnecessary using of processing and network resources. The duplicate transmission of data may complicate data handling on the cloud side (e.g., by the data consuming service), as services may use processing resources to reconcile potentially conflicting information from multiple sources.

Certain implementations of this disclosure provide a cloud-based collector coordination engine that manages multiple on-premises virtualization data collectors connected to virtualization managers. A collector coordination engine in the cloud receives registration information from virtualization data collectors as the data collectors come online. The collector coordination engine may maintain a collector mapping of which virtualization data collectors are configured to collect data from which virtualization managers (or clusters associated with a virtualization manager). The coordination engine may designate active and standby virtualization data collectors for each virtualization manager and/or cluster such that active virtualization data collectors collect that data from the virtualization manager and/or cluster and transmit the collected data to the data consumer service in the cloud network. Depending on implementation, standby virtualization data collectors might or might not collect the data from the virtualization manager and/or cluster but, in either case, refrain from transmitting the data (collected or not) to the data consumer service in the cloud network. The collector coordination engine may update the collector mapping to reflect the reporting status (e.g., active or standby) of the virtualization data collectors relative to particular virtualization managers and/or clusters. The collector coordination engine may balance load across virtualization data collectors and may provide automatic failover if an active virtualization data collector becomes unavailable.

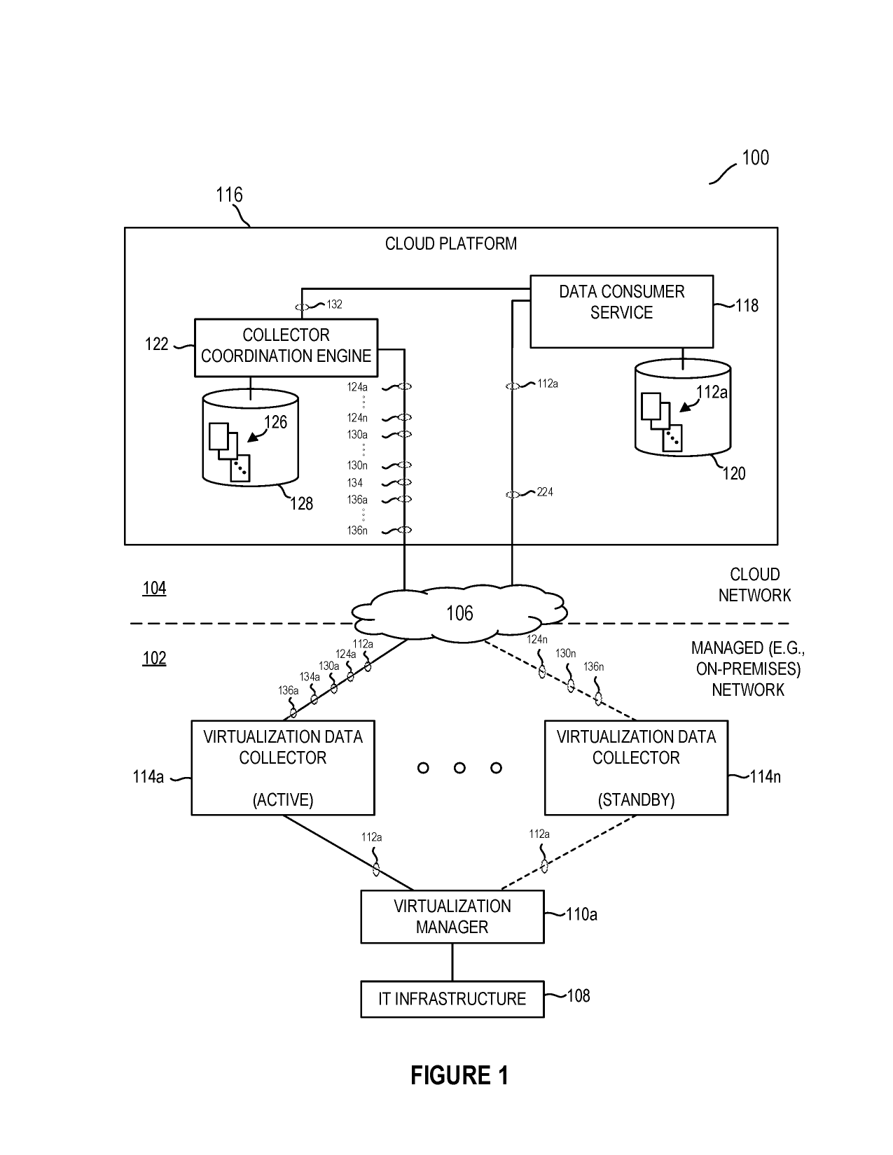

Turning to the figures, FIG. 1 illustrates an example system 100 for coordinating data collectors of a managed computing network, according to certain implementations. In the illustrated example, system 100 includes a managed network 102 and a cloud network 104, components of which communicate via a network 106. Although a particular implementation of system 100 is illustrated and described, this disclosure contemplates any suitable implementation of system 100. In general, system 100 may facilitate coordinating the transmission of data collected in managed network 102 by virtualization data collectors from one or more data sources to a data consumer service in cloud network 104.

Managed network 102 may be any suitable type of computing network that is managed through another computing device or computing network (e.g., cloud network 104). In certain implementations, managed network 102 may include an on-premise private network. The term “on-premise” may include, for example, computing resources on location at one or more physical premises (e.g., one or more data centers) owned (fully or partially), operated, or subscribed by an entity or at a colocation center rented to the entity. Managed network 102 may be referred to as a managed network 102 of an entity. The term “entity” may refer to an individual or an organization having one or more users (e.g., owners, employees, contractors, or administrators).

Managed network 102 may be a data center or other computing environment that includes an IT infrastructure 108. IT infrastructure 108 may include a network of IT resources hosted on-premise. Examples of the IT resources of IT infrastructure 108 hosted in managed network 102 may include servers, storage devices, network switches, routers, mobile communication devices, desktop computers, portable computers, computing system resource enclosures, and/or wireless local area network (WLAN) access points. The servers may be blade servers, for example. The storage devices may be storage blades or storage arrays, for example. Further, the computing system enclosures may be a blade enclosure housing one or more blades (e.g., blade servers, storage blades, etc.). In certain implementations, IT infrastructure 108 may include multiple sets of resources, with each set including compute, network, and storage resources. IT infrastructure 108 may be implemented using any suitable combination of hardware, firmware, and software.

One or more of the IT resources may allow applications and/or application management platforms (e.g., a container management platform, a VM management system, machine-learning platforms, and the like) to run thereon. For example, the IT resources may allow a virtualization manager to run on the IT resources of IT infrastructure 108. Such applications running on the IT resources of IT infrastructure 108 of managed network 102 may be referred to as on-premise applications and/or data sources.

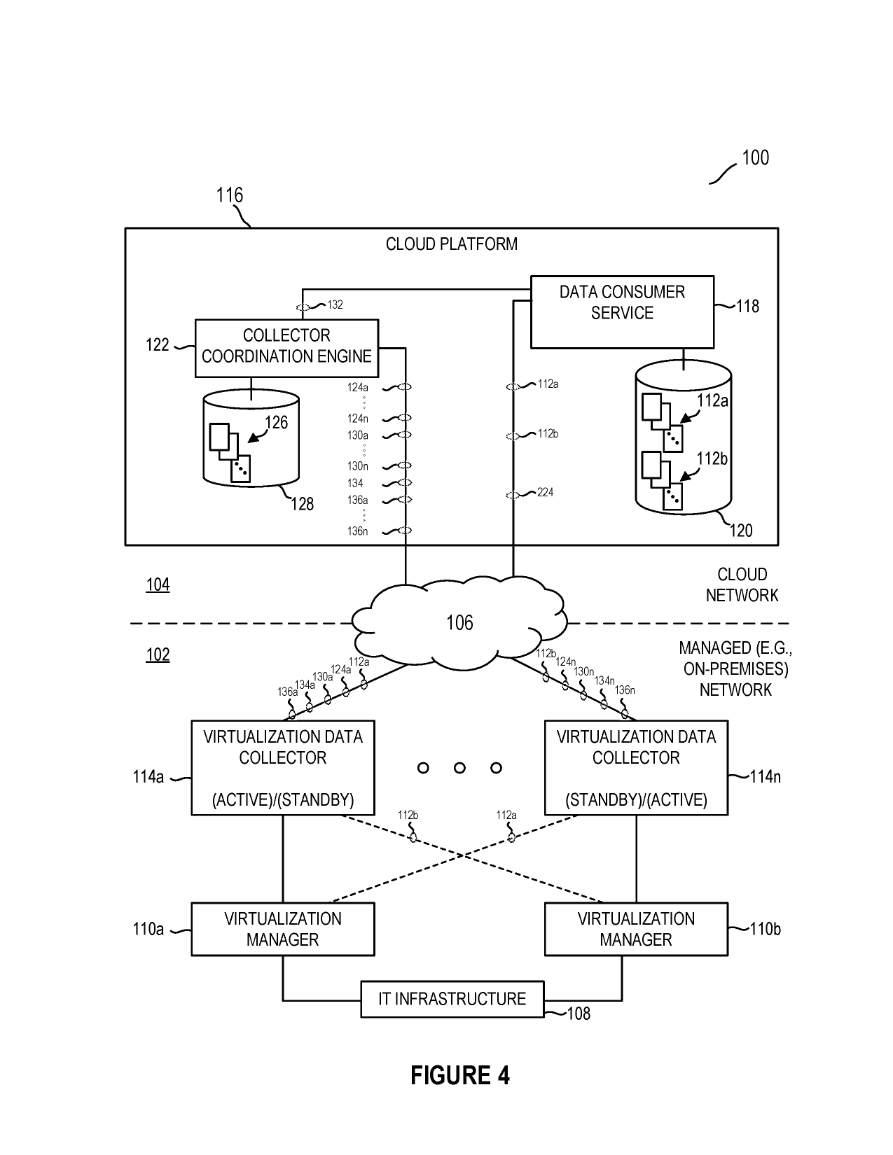

In the illustrated example, managed network 102 includes virtualization manager 110a as an example application that may operate using IT infrastructure 108. Virtualization manager 110a is referred to using the identifier “110a” because a later example shows an implementation of system 100 with an additional virtualization manager (see FIG. 4). These virtualization managers may be referred to generally as virtualization managers 110 throughout this disclosure. Although referred to as a virtualization manger, virtualization manager 110 may include any suitable type of application or resource that generates data in association with operation of managed network 102. Virtualization managers 110 may be implemented using any suitable combination of hardware, firmware, and software.

Virtualization manager 110 (whether virtualization manager 110a or virtualization managers 110 more generally) may provide a management platform for managing virtualization environment using IT infrastructure 108. In a particular example, virtualization manager 110 may be VCENTER by VMWARE, although this disclosure contemplates virtualization manager 110 being any suitable virtualization manager framework.

Virtualization manager 110 may generate data 112 associated with the virtual environments created using and/or managed by virtualization manager 110 and/or other aspects of IT infrastructure 108. In certain implementations, data 112 generated by or otherwise obtained by virtualization manager 110 may include inventory and/or performance data associated with IT infrastructure 108 and/or the services provided by virtualization manager 110. For example, data 112 may include inventory information about virtual machines, hosts, and clusters, as well as performance metrics related to central processing unit (CPU) usage, memory utilization, storage capacity and utilization, network traffic, as just a few examples.

Managed network 102 may include one or more data collectors 114. In the illustrated example, managed network 102 includes data collector 114a through data collector 114n, with n representing any suitable integer. Data collectors 114a through 114n may be referred to generally as data collectors 114 or data collector 114. Virtualization data collectors 114 may collect data 112 from virtualization manager 110 and transmit that data 112 to one or more recipients, such as a data consumer service of cloud network 104, as described in greater detail below. Virtualization data collectors 114 may be implemented using any suitable combination of hardware, firmware, and software.

Cloud network 104 may be a public cloud network which may include a network of IT resources (potentially similar to the IT resources of IT infrastructure 108, for example) that are interconnected via the Internet, collocated at a common place, distributed among several geographical locations. Cloud network 104 may be external to managed network 102.

Managed network 102 and cloud network 104 may provide one or more services to an entity associated with managed network 102. The services may include, for example, storage, compute, and/or networking capabilities offered by the IT resources of cloud network 104 and/or the managed network 102. The services may be accessed by authorized users of cloud network 104 via a cloud platform 116 hosted on cloud network 104. Cloud platform 116 may provide one or more tenants a cloud-like experience by allowing management and/or usage of capabilities such as, for example, IT infrastructure and/or services offered by respective on-premise networks. A “tenant” of cloud platform 116 may refer to an entity (and one or more associated users) that is registered with cloud platform 116 to use services offered by cloud platform 116. Throughout this description services offered by cloud platform 116 are described with reference to a single managed network 102 associated with an entity that is registered with cloud platform 116 as a tenant. This disclosure contemplates cloud platform 116 managing multiple managed networks and having multiple tenants.

Accordingly, in some examples, the users associated with a tenant entity may access one or more of several applications, such as virtual machines, containers, pods, machine-learning operations, data storage, compute, virtual networking, or the like, hosted on managed network 102 of the entity as services via the cloud platform 116. Cloud platform 116 may provide a cloud-like experience to one or more tenants to use applications and/or services hosted on a corresponding managed network 102. In certain implementations, IT infrastructure 108 may be managed by the tenant entity itself or by a third-party organization via a management platform such as cloud platform 116. The management and/or consumption of the IT infrastructure 108 and associated applications and management resources (e.g., virtualization manager 110) may be facilitated in a cloud-like manner via cloud platform 116 to the users associated with a tenant entity everywhere one needs. Examples of the services of managed network 102 and/or public cloud services managed by cloud platform 116 may include containers, virtual machines, bare metal, machine learning, database platform, private cloud, data protection, networking, storage, compute, and high-performance computing. Users of a tenant may run various workloads using the foregoing example applications.

Cloud platform includes a data consumer service 118. Data consumer service 118 may be any type of service that obtains data 112 from virtualization data collectors 114 of managed network 102. In certain implementations, data consumer service 118 may be associated with a service of cloud platform 116 for managing managed network 102. Data consumer service 118 may obtain data 112 from virtualization data collectors 114 for any suitable reason. For example, data consumer service 118 may obtain data 112 from virtualization data collectors 114 so that cloud platform 116 periodically obtains an up-to-date view of the status of at least a portion of managed network 102. Data consumer service 118 may be implemented using any suitable combination of hardware, firmware, and software.

Data consumer service 118 may store data 112 received from virtualization data collectors 114 in a storage device 120. In this particular example, for reasons described below, data consumer service 118 stores data 112a received from virtualization data collector 114a in storage device 120. Storage device 120 may take the form of volatile and/or non-volatile memory including, without limitation, magnetic media, optical media, read-access memory (RAM), read-only memory (ROM), removable media, or any other suitable memory component. In certain implementations, a portion or all of storage device 120 may be or include a database, such as one or more structured query language (SQL) servers or relational databases. Storage device 120 may be separate from or part of data consumer service 118. Although referred to in the singular, storage device 120 may be multiple storage devices at one or more locations.

Managed network 102 and cloud network 104 may communicate via network 106. Network 106 may be any suitable type of communication network for electronic devices, and may facilitate wired and/or wireless communication. Network 106 may communicate, for example, IP packets, Frame Relay frames, ATM cells, voice, video, data, and other suitable information between network addresses. Network 106 may include any suitable combination of one or more LANs, radio access networks (RANs), metropolitan area networks (MANs), wide area networks (WANs), mobile networks (e.g., using WiMax (802.16), WiFi (802.11), 3G, 4G, 5G, or any other suitable wireless technologies in any suitable combination), all or a portion of the global communication network known as the Internet, and/or any other communication system or systems at one or more locations, any of which may be any suitable combination of wireless and wired. Network 106 may include controllers, access points (APs), switches, routers, firewalls, or the like for forwarding traffic.

As described above, managed network 102 may include multiple virtualization data collectors 114, more than one of which may collect partially or completely redundant data 112 from data sources such as virtualization manager 110a. In many scenarios, data 112 may be voluminous. Transmitting this collected data 112 from multiple virtualization data collectors 114 to data consumer service 118 may be burdensome on networking resources and processing resources of both managed network 102 and cloud network 104.

System 100, and in the illustrated example cloud network 104, includes collector coordination engine 122. Collector coordination engine 122 may coordinate transmission of data 112 from virtualization data collectors 114 to data consumer service 118 to reduce or eliminate redundant transmission of data 112 to data consumer service 118. To coordinate virtualization data collectors 114, collector coordination engine 122 may determine from among multiple virtualization data collectors 114 that collect data 112 from a data source (e.g., virtualization manager 110a), a subset of virtualization data collectors 114 that are to transmit data 112 to data consumer service 118. In certain implementations, the subset includes a single virtualization data collector 114 that is designated to send data 112 to data consumer service 118.

In certain implementations, for each virtualization data collector 114 that reports to collector coordination engine 122, collector coordination engine 122 may determine a reporting status of the virtualization data collector 114 for each data source (e.g., virtualization manager 110) from which that virtualization data collector 114 collects data 112. In certain implementations, the reporting status may include an active reporting status or a standby reporting status. An active reporting status may indicate that a virtualization data collector 114 is to transmit data 112 to data consumer service 118. A standby reporting status may indicate that a virtualization data collector 114 is to continue to collect data 112 from a data source (e.g., virtualization manager 110), but is to refrain from transmitting data 112 to data consumer service 118. In certain implementations, an active reporting status may indicate that a virtualization data collector 114 is both to collect data 112 from a data source (e.g., virtualization manager 110) and to transmit data 112 to data consumer service 118, while a standby reporting status may indicate that a virtualization data collector 114 is to refrain from both collecting data 112 from a data source (e.g., virtualization manager 110) and transmitting data 112 to data consumer service 118. In certain implementations, an active reporting status may indicate that a virtualization data collector 114 is both to collect data 112 from a data source (e.g., virtualization manager 110) and transmit data 112 to data consumer service 118, while a standby reporting status may indicate that a virtualization data collector 114 is to collect data 112 from a data source (e.g., virtualization manager 110) but to refrain from transmitting the collected data 112 to data consumer service 118.

To that end, as virtualization data collectors 114 come online, virtualization data collectors 114 may send registration information to collector coordination engine 122. In the illustrated example, virtualization data collector 114a sends registration information 124a, and virtualization data collector 114n send registration information 124n. Registration information may be referred to generally as registration information 124. Registration information 124 for a virtualization data collector 114 may include an identifier of the virtualization data collector 114 that transmitted the registration information 124 and an identifier of the one or more data sources (e.g., virtualization managers 110) from which the virtualization data collector 114 that transmitted the registration information 124 collect data 112.

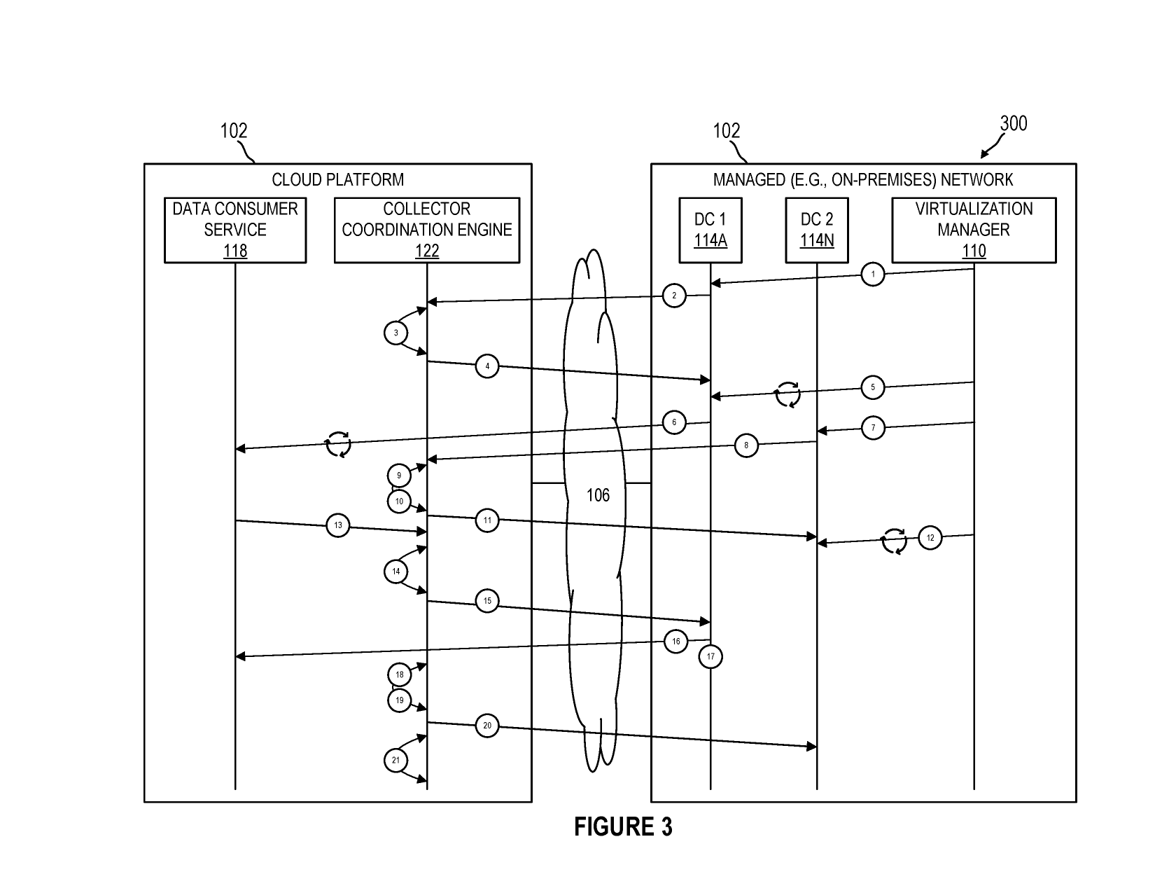

The registration process for virtualization data collectors 114 may facilitate initializing and maintaining the coordination between virtualization data collectors 114 and collector coordination engine 122. This process may assist collector coordination engine 122 in having an up-to-date view of available virtualization data collectors 114 and their associated data sources (e.g., virtualization managers 110 and/or computing clusters). Additional details of virtualization data collector 114 registration are described below with reference to FIG. 3.

In certain implementations, collector coordination engine 122 determines only a single virtualization data collector 114 to transmit data 112 to data consumer service 118. This disclosure, however, contemplates collector coordination engine 122 identifying more than one virtualization data collector 114 to transmit data 112 to data consumer service 118. As long as the determined number of virtualization data collectors 114 that are determined to transmit data 112 to data consumer service 118 are less than the total number of virtualization data collectors 114 that collect data 112 and would otherwise transmit data 112 to data consumer service 118, a reduction in resource usage may be achieved.

In the illustrated example, collector coordination engine 122 receives registration information 124a through 124n from virtualization data collectors 114a-114n, respectively. In this example, collector coordination engine 122 determines that virtualization data collector 114a is to have a reporting status of active such that virtualization data collector 114a is to collect data 112 from virtualization manager 110a and transmit data 112 collected from virtualization manager 110a to data consumer service 118. Additionally, in this example, collector coordination engine 122 determines that virtualization data collector 114n (and any virtualization data collectors 114 between virtualization data collector 114a and virtualization data collector 114n) are to have a reporting status of standby. In certain implementations, a reporting status of standby includes virtualization data collector 114n (and any virtualization data collectors 114 between virtualization data collector 114a and virtualization data collector 114n) collecting data 112a from virtualization manager 110a, but refraining from transmitting data 112a to data consumer service 118. Alternatively, in certain implementations, a reporting status of standby includes virtualization data collector 114n (and any virtualization data collectors 114 between virtualization data collector 114a and virtualization data collector 114n) refraining both from collecting data 112a from virtualization manager 110a and from transmitting data 112a to data consumer service 118.

In certain implementations, collector coordination engine 122 may maintain one or more collector mappings 126, and may store those collector mappings 126 in a storage device 128. Storage device 128 may take the form of volatile and/or non-volatile memory including, without limitation, magnetic media, optical media, RAM, ROM, removable media, or any other suitable memory component. In certain implementations, a portion or all of storage device 128 may be or include a database, such as one or more SQL servers or relational databases. Storage device 128 may be separate from or part of data consumer service 118, and may be separate from or the same as storage device 120. Although referred to in the singular, storage device 128 may be multiple storage devices at one or more locations. Collector coordination engine 122 may store multiple collector mappings, such as different collector mappings 126 for different tenants or for any other suitable purpose. Collector mappings 126 may be referred to in the singular or the plural.

In response to receiving registration information 124 for a virtualization data collector 114, collector coordination engine 122 may create one or more entries for the virtualization data collector 114 in collector mapping 126. The entries for a virtualization data collector 114 may indicate the data source(s) (e.g., virtualization manager(s) 110) from which the virtualization data collector 114 collects data 112 and a corresponding reporting status for each data source from which the virtualization data collector 114 collects data 112.

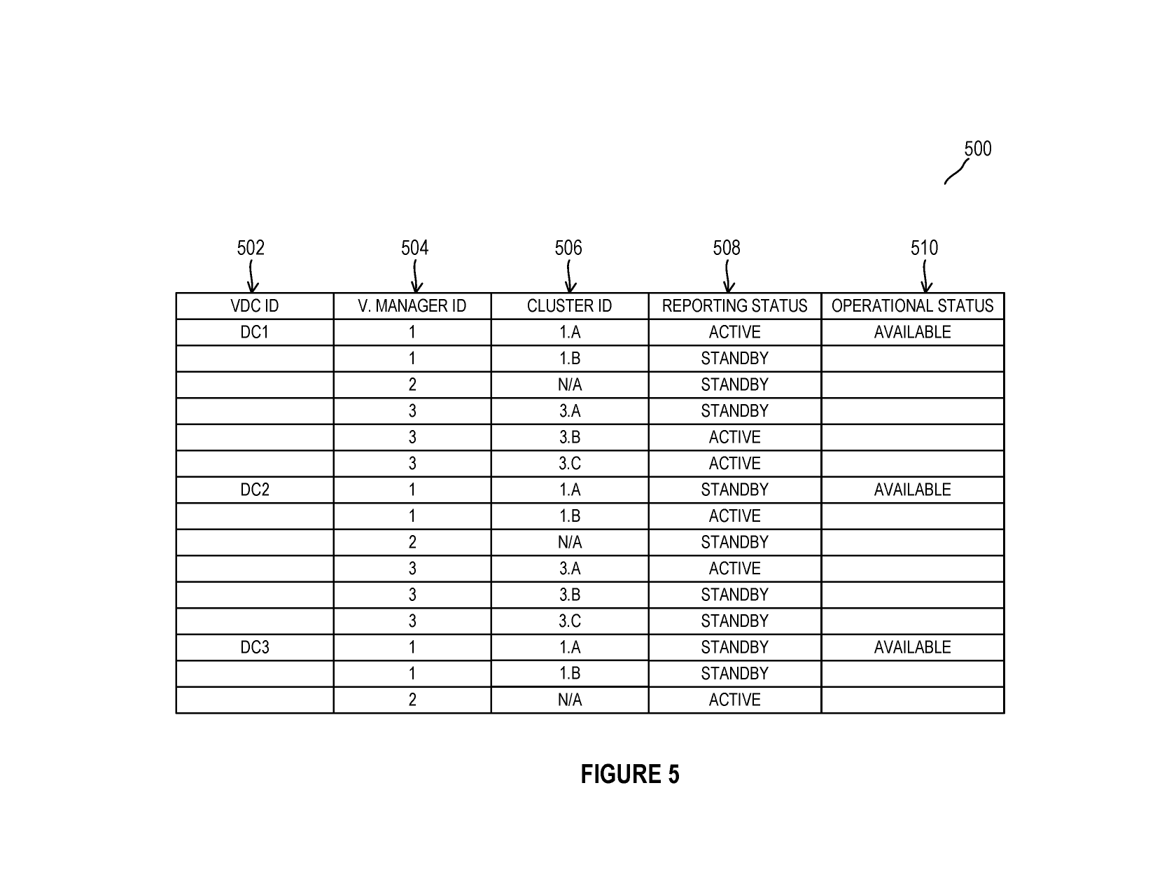

Collector mapping 126 may map virtualization data collectors 114 to one or more virtualization managers 110 (e.g., virtualization manager 110a). As collector coordination engine 122 makes determinations regarding which virtualization data collectors 114 will have an active reporting status for particular data sources (e.g., virtualization managers 110) and which will have a standby reporting status for particular data sources (e.g., virtualization managers 110), collector coordination engine 122 may update collector mapping 126 according to the reporting status determinations. For example, based on the determination that virtualization data collector 114a will have an active reporting status for virtualization manager 110a in FIG. 1 and that virtualization data collector 114n (and possibly other virtualization data collectors 114) will have a standby reporting status for virtualization manager 110a, collector coordination engine 122 may update collector mapping to reflect those reporting status determination. To the extent collector coordination engine 122 determines a reporting status of virtualization data collectors 114 for particular computing clusters managed by virtualization managers 110, collector mapping 126 may include an indication of the reporting status of virtualization data collectors 114 for particular computing clusters. Additional details of an example collector mapping in accordance with certain implementations are described below with reference to FIG. 5.

Collector coordination engine 122 may configure virtualization data collectors 114 according to the reporting status(es) determined by collector coordination engine 122. Example techniques for configuring virtualization data collectors 114 according to determined reporting statuses are described below.

For example, if collector coordination engine 122 determines that a particular virtualization data collector 114 is to have a reporting status of active for a particular data source (e.g., virtualization manager 110), then collector coordination engine 122 may configure that virtualization data collector 114 to have a reporting status of active for the particular data source (e.g., virtualization manager 110). That is, if collector coordination engine 122 determines that a particular virtualization data collector 114 is to transmit data 112 for a particular data source (e.g., virtualization manager 110) (e.g., is to have a reporting status of active for that data source), then collector coordination engine 122 may configure that virtualization data collector 114 to transmit data 112 for the particular data source (e.g., virtualization manager 110) (e.g., to have a reporting status of active for that data source). In certain implementations, configuring a particular virtualization data collector 114 to have a reporting status of active for a particular data source (e.g., virtualization manager 110) includes configuring the particular virtualization data collector 114 to collect data 112 for the particular data source (e.g., virtualization manager 110), such as in implementations in which virtualization data collectors 114 that have a reporting status of standby do not collect data 112 from data sources or if the particular virtualization data collector 114 is not already configured to collect data 112 from the particular data source for some other reason.

As another example, if collector coordination engine 122 determines that a particular virtualization data collector 114 is to have a reporting status of standby for a particular data source (e.g., virtualization manager 110), then collector coordination engine 122 may configure that virtualization data collector 114 to have a reporting status of standby for the particular data source (e.g., virtualization manager 110). That is, if collector coordination engine 122 determines that a particular virtualization data collector 114 is not to transmit data 112 for a particular data source (e.g., virtualization manager 110) (e.g., is to have a reporting status of standby for that data source), then collector coordination engine 122 may configure that virtualization data collector 114 to refrain from transmitting data 112 for the particular data source (e.g., virtualization manager 110) (e.g., to have a reporting status of standby for that data source). In certain implementations, configuring a particular virtualization data collector 114 to have a reporting status of standby for a particular data source (e.g., virtualization manager 110) includes configuring the particular virtualization data collector 114 not to collect data 112 for the particular data source (e.g., virtualization manager 110), such as in implementations in which virtualization data collectors 114 that have a reporting status of standby do not collect data 112 from data sources.

In certain implementations, to configure a virtualization data collector 114 according to the registration status determined by collector coordination engine 122, collector coordination engine 122 may transmit reporting instructions 130 to virtualization data collectors 114. For example, to configure a virtualization data collector 114 to transmit data 112 for the particular data source (e.g., virtualization manager 110) (e.g., to have a reporting status of active for that data source), collector coordination engine 122 may transmit a reporting instruction 130 to that virtualization data collector 114 to cause that virtualization data collector 114 to transmit data 112 for the particular data source to data consumer service 118 (e.g., virtualization manager 110) (e.g., to have a reporting status of active for that data source). As another example, to configure a virtualization data collector 114 to refrain from transmitting data 112 for the particular data source (e.g., virtualization manager 110) (e.g., to have a reporting status of active for that data source), collector coordination engine 122 may transmit a reporting instruction 130 to that virtualization data collector 114 to cause that virtualization data collector 114 to refrain from transmitting data 112 for the particular data source to data consumer service 118 (e.g., virtualization manager 110) (e.g., to have a reporting status of active for that data source).

In certain implementations, such as some implementations in which virtualization data collectors 114 that have a reporting status of standby do not collect data 112 from data sources, the reporting instructions 130 may include an instruction to collect or not collect data 112 from data sources. In such an example, reporting instructions 130 may indicate to a particular virtualization data collector 114 being configured with a reporting status of active for a particular data source that the particular virtualization data collector 114 is to collect data 112 from the particular data source. Additionally or alternatively, in such an example, reporting instructions 130 may indicate to a particular virtualization data collector 114 being configured with a reporting status of standby for a particular data source that the particular virtualization data collector 114 is not to collect data 112 from the particular data source. In some implementations, whether or not to include an instruction to collect or not collect data 112 from data sources may depend at least in part on a current reporting status of a particular virtualization data collector 114 and/or default data collection behavior of virtualization data collectors 114. Additionally or alternatively, reporting instructions 130 might include a desired collection behavior (collect or do not collect data 112) regardless of other factors, such as a current reporting status of a particular virtualization data collector 114 and/or default data collection behavior of virtualization data collectors 114.

In the illustrated example, collector coordination engine 122 determines that virtualization data collector 114a is to collect and transmit data 112a for virtualization manager 110a (e.g., is to have a reporting status of active for that virtualization manager 110a), and may configure virtualization data collector 114a to transmit data 112a for virtualization manager 110a to data consumer service 118 (e.g., to have a reporting status of active for virtualization manager 110a). Collector coordination engine 122 may transmit a reporting instruction 130a to virtualization data collector 114a to cause that virtualization data collector 114a to collect and transmit data 112a for virtualization manager 110a to data consumer service 118 (e.g., to have a reporting status of active for that data source). Additionally, in the illustrated example, collector coordination engine 122 determines that the one or more virtualization data collectors 114 between virtualization data collector 114a and virtualization data collector 114n are to refrain from transmitting (and possibly refrain from collecting) data 112a for virtualization manager 110a (e.g., are to have a reporting status of active for that virtualization manager 110a), and may configure the virtualization data collectors 114 between virtualization data collector 114a and virtualization data collector 114n to refrain from transmitting (and possibly refrain from collecting) data 112a for virtualization manager 110a to data consumer service 118 (e.g., to have a reporting status of standby for virtualization manager 110a). Collector coordination engine 122 may transmit a reporting instruction (one or more reporting instructions through 130n) to virtualization data collectors 114 other than 114a (one or more virtualization data collectors 114 through virtualization data collector 114n) to cause those virtualization data collectors 114 to refrain from transmitting data 112a for virtualization manager 110a to data consumer service 118 (e.g., to have a reporting status of standby for that data source).

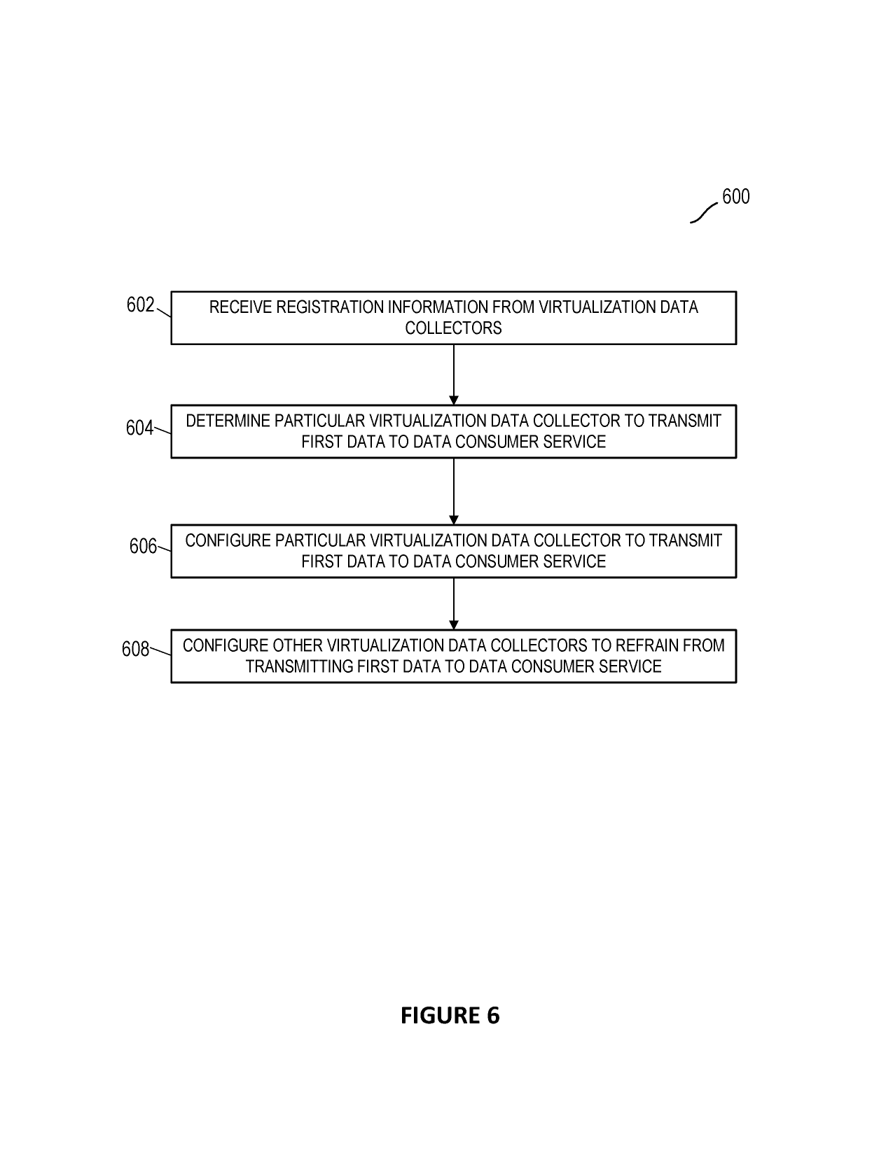

Collector coordination engine 122 may determine which virtualization data collector 114 will be the active virtualization data collectors 114 for transmitting data 112 to data consumer service 118 in any suitable manner and according to any suitable criteria. In certain implementations, collector coordination engine 122 may determine which virtualization data collector 114 will be the active virtualization data collector 114 for transmitting data 112 to data consumer service 118 according to load balancing considerations. Aspects of load balancing are described in greater detail below with reference to FIG. 6.

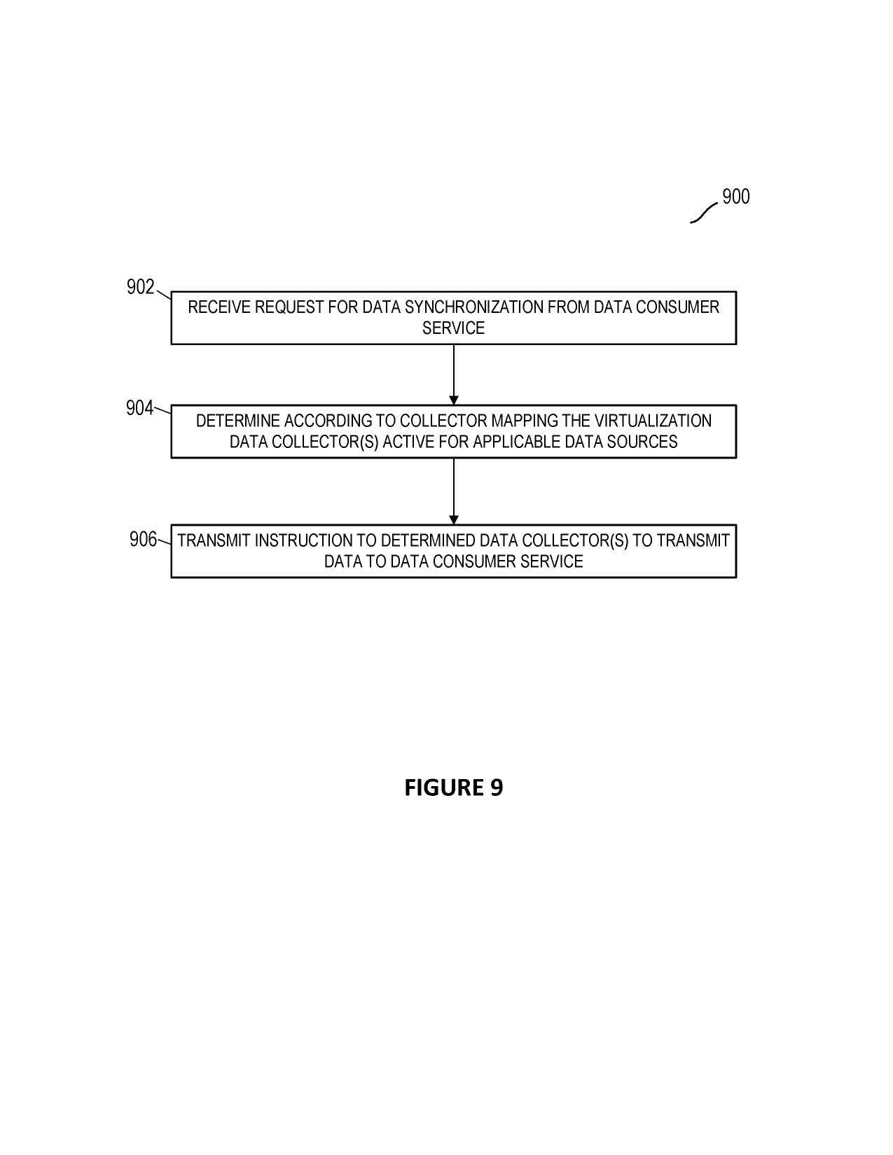

In certain implementations, data consumer service 118 may be configured to communicate a data synchronization (or sync) request 132 to collector coordination engine 122. Data synchronization request 132 could be a request to synchronize data for all data sources (e.g., virtualization managers 110 and/or computing clusters) of data consumer service 118 or for particular data sources of data consumer service 118. In response to such a request, collector coordination engine 122 may transmit a synchronization instruction 134 to the appropriate one or more virtualization data collectors 114 to cause those one or more virtualization data collectors 114 to transmit data 112 to data consumer service 118. In some scenarios, virtualization data collectors 114 are configured to transmit data 112 to data consumer service 118 when the data changes or at another suitable interval. Data synchronization request 132 provides a technique for data consumer service 118 to request a synchronization of data with virtualization data collectors 114. Example techniques for data synchronization are described in greater detail below with reference to at least FIGS. 3 and 9.

In certain implementations, during operation collection coordination engine 122 may monitor the operational status of virtualization data collectors 114 to detect whether a virtualization data collector 114 becomes unavailable. A virtualization data collector 114 might become temporarily or permanently unavailable for any of a variety of reasons, such as failure of a device on which virtualization data collector 114; rebooting of the device on which virtualization data collector 114 is operating, a software failure of virtualization data collector 114, an upgrade of virtualization data collector 114, a failure of a network connection associated with virtualization data collector 114, or any other suitable reason. In certain implementations, collector coordination engine 122 may include an operational status of virtualization data collectors 114 in collector mapping 126.

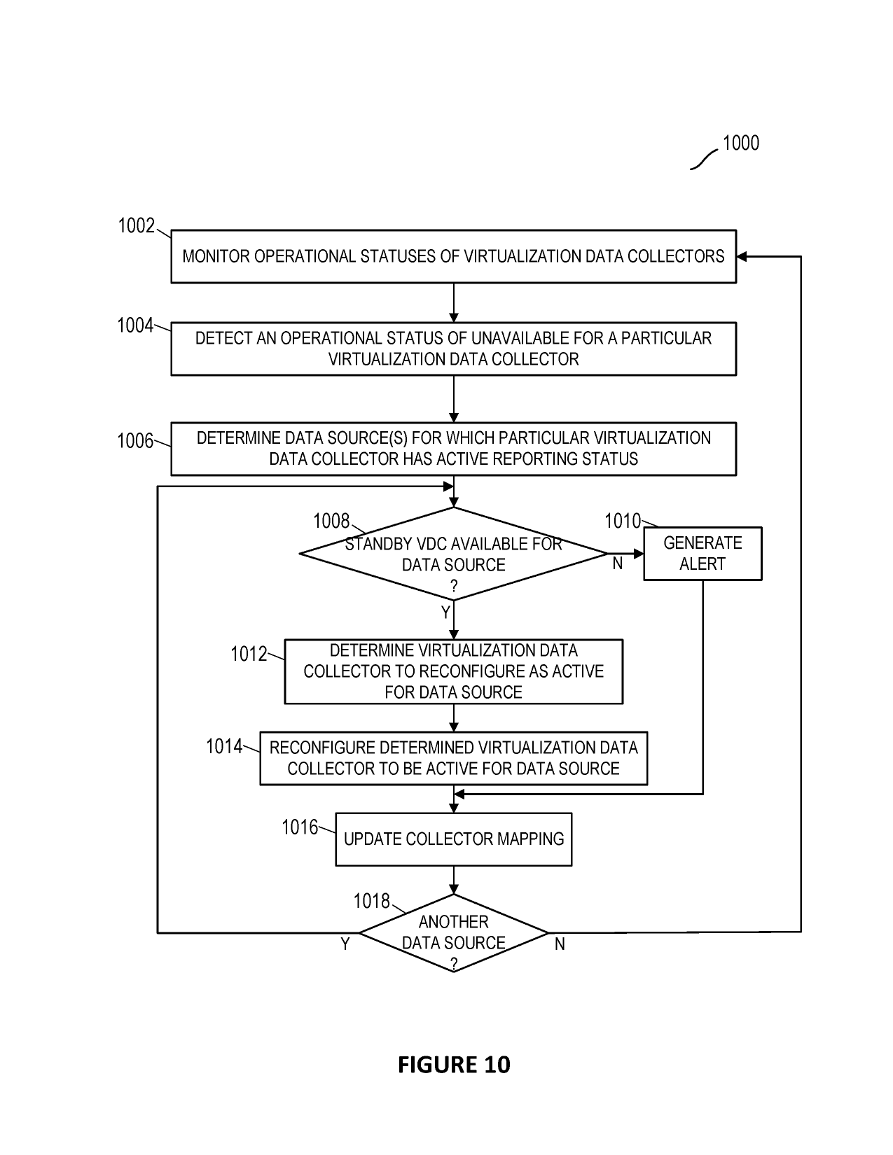

To that end, collector coordination engine 122 may receive operational availability information 136 from virtualization data collectors 114. In the illustrated example, collector coordination engine 122 may receive operational availability information 136a through 136n from virtualization data collectors 114a through 114n, which may be referred to generally as operational availability information 136. Operational availability information 136 may include a heartbeat associated with virtualization data collectors 114 and/or any other suitable information that may assist collector coordination engine 122 in determining an operational status of virtualization data collectors 114. In response to detecting that a virtualization data collector 114 for a particular data source (e.g., virtualization manager 110) has become unavailable, collector coordination engine 122 may attempt to determine and reconfigure another virtualization data collector 114 (e.g., a virtualization data collector 114 that has a reporting status of standby for the particular data source) to have an operational status of active. Example techniques for a failover operation are described in greater detail below with reference to at least FIGS. 3 and 10.

While FIG. 1 illustrates a particular configuration of components, this disclosure contemplates other suitable configurations. For example, although FIG. 1 shows certain components as being part of the same device, any of the components may be grouped in sets of one or more components which may exist and execute as part of any number of separate and operatively connected devices. As another example, a single component may be configured to perform all or any portion of the functionality performed by the components shown in FIG. 1. Accordingly, implementations disclosed herein should not be limited to the configuration of components shown in FIG. 1.

FIG. 1 illustrates collector coordination engine 122 being located in cloud network 104. This disclosure, however, contemplates collector coordination engine 122 being located in managed network 102 or at any other suitable location.

Although FIG. 1 illustrates and describes virtualization manager 110 and/or one or more clusters of a virtualization manager 110 being the source of data 112, this disclosure contemplates any suitable data sources of data 112 in a managed network 102 that may be collected by virtualization data collectors 114 (or other suitable types of data collectors) and transmitted to data consumer service 118 in a cloud network 104. In other words, FIG. 1 illustrates virtualization manager 110 (and particularly virtualization manager 110a) as a data source for data to be communicated to data consumer service 118. This disclosure, however, contemplates managed network 102 including any suitable number and types of data sources that might produce data for communication to data consumer service 118 via virtualization data collectors 114. For example, a data source may include a virtual machine, a container, a containerized application, a pod, or a machine-learning application. This disclosure is not limited to any particular type of data source.

This disclosure contemplates the components communicating messages/information to one another in any suitable manner and according to any suitable protocol, alone or in combination. In certain implementations, certain components may use message queues or publish-subscribe mechanisms to facilitate efficient and scalable communication between components. For example, APACHE KAFKA and associated KAFKA topics may be used for at least a portion of the communications between virtualization data collectors 114 and collector coordination engine 122, and between virtualization data collectors 114 and data consumer service 118. For example, virtualization data collectors 114 and collector coordination engine 122 may communicate using one or more KAFKA topics. A KAFKA topic may serve as a category or feed name to which messages are published, allowing for organized and targeted communication. As a particular example, virtualization data collectors 114 may communicate registration information 124 and other messages to collector coordination engine 122 using a suitably identified KAFKA topic (e.g., a “virtualization” topic), which may be referred to as publishing a message to that KAFKA topic. As another example, a virtualization data collector 114 that has an active status may communicate data to data consumer service 118 using one or more KAFKA topics. A recipient component may subscribe to a KAFKA topic to receive messages related to that KAFKA topic.

The use of distinct KAFKA topics for different types of messages (e.g., registration information, collected data, control messages) may allow the system to logically separate different streams of communication. This separation may allow efficient routing of messages and may allow components to focus on processing the message types relevant to their function. For example, collector coordination engine 122 may publish decisions about which virtualization data collectors 114 should be active or standby to a specific KAFKA topic. The virtualization data collectors 114 may subscribe to this topic, allowing the virtualization data collectors 114 to receive and act on these instructions.

In certain implementations, certain components may use message remote procedure calls (RPCs) to facilitate communication between components. For example, gRPC may be used for at least a portion of the communications between virtualization data collectors 114 and collector coordination engine 122, and between virtualization data collectors 114 and data consumer service 118. In certain implementations, collector coordination engine 122 may use gRPC to communicate with the virtualization data collectors 114. gRPC is an open-source framework that may use HTTP/2 for transport and protocol buffers as the interface description language. gRPC may provide bidirectional streaming. A gRPC service may be defined using protocol buffers, specifying methods for virtualization data collector 114 registration, status updates, mode setting, and data collection control.

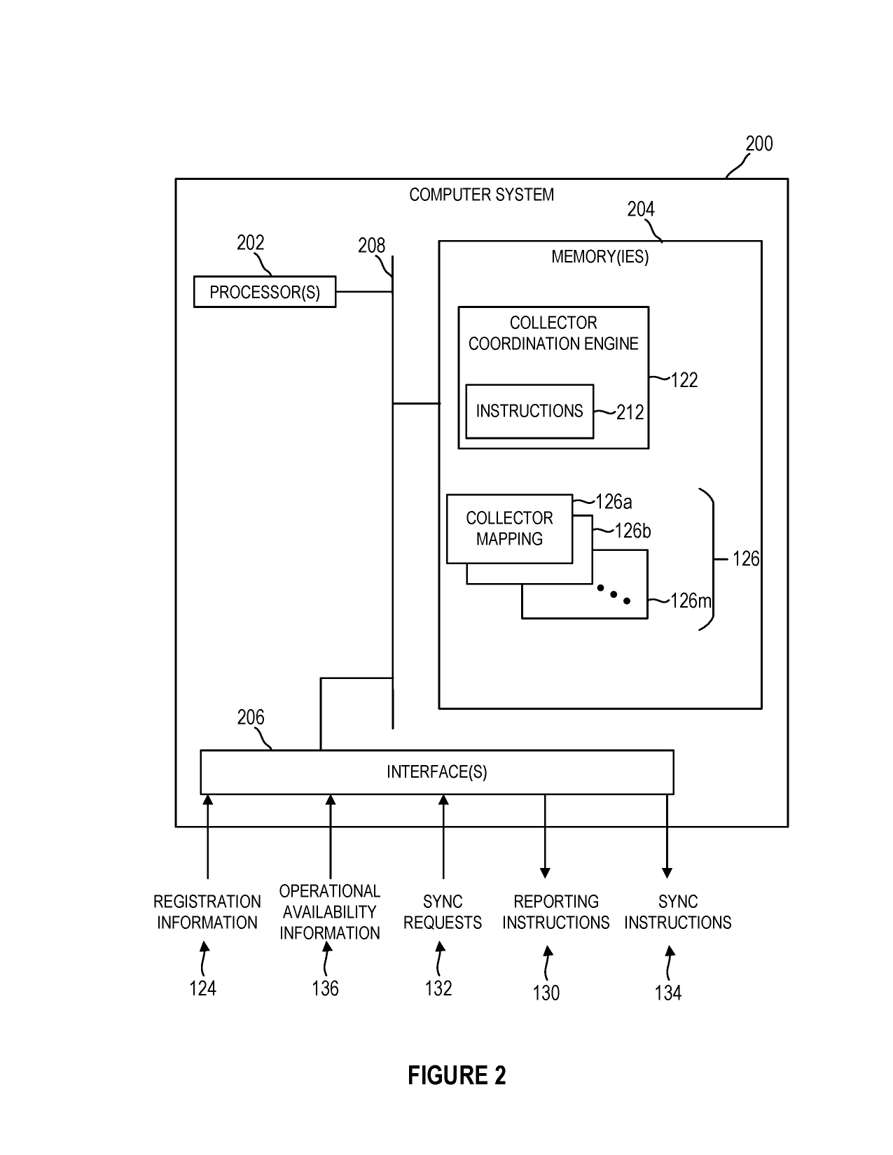

FIG. 2 illustrates an example computer system 200 on which collector coordination engine 122 may be run, according to certain implementations. In the illustrated example, computer system 200 includes one or more processors 202, memory 204, and one or more interfaces 206, all or a portion of which may communicate using links 208, and all of which may be referred to in the singular for simplicity. The components of computer system 200 may be implemented in any suitable combination of hardware, firmware, and software. Portions of computer system 200 may described with reference to aspects of system 100 shown in FIG. 1.

Processor 202 may be any component or collection of components adapted to perform computations and/or other processing-related tasks. Processor 202 can be, for example, a microprocessor, a microcontroller, a control circuit, a digital signal processor, a field-programmable gate array (FPGA), an application-specific integrated circuit (ASIC), a system-on-chip (SoC), or combinations thereof. Processor 202 may include one or more processing cores. Processor 202 may include any suitable number of processors, or multiple processors may collectively form a single processor 202.

Memory 204 may include any suitable combination of volatile memory, non-volatile memory, and/or virtualizations thereof. For example memory may include any suitable combination of magnetic media, optical media, RAM, ROM, removable media, and/or any other suitable memory device. Memory 204 may include data structures used to organize and store all or a portion of the stored data. Memory 204 may include a non-transitory computer-readable medium that stores programming for execution by one or more of the one or more processor 202.

Interfaces 206 represent any suitable computer element that can receive information from a communication network (e.g., network 106) and transmit information through a communication network (e.g., network 106), or both. Interfaces 206 represent any port or connection, real or virtual, including any suitable combination of hardware, firmware, and software, including protocol conversion and data processing capabilities, to communicate through a LAN, WAN, or other communication system that allows information to be exchanged. Interfaces 206 may facilitate wireless and/or wired communication.

Links 208 may include any suitable wired or wireless communication medium for the components of computer system 200 to communicate with one another. For example, links 208 may include any suitable combination of a bus or communication network.

Returning to memory 204, in the illustrated example, memory 204 stores collector coordination engine 122 and collector mappings 126 (e.g., shown to include collector mappings 126a through 124m). Collector coordination engine 122 may be configured to perform the operations described throughout this disclosure for coordinating the transmission of data (e.g., data 112) collected by virtualization data collectors 114 from one or more data sources (e.g., virtual managers 110) to a data consumer service 118.

Collector coordination engine 122 may be implemented using any suitable combination of hardware, firmware, and software. One or more modules of computer system 200 may be partially or wholly embodied as software and/or hardware for performing any functionality described herein. For example, some or all of collector coordination engine 122 may be embodied as software. Collector coordination engine 122 may include programming for execution by processor 202, the programming including instructions 210 to perform some or all of the functionality of collector coordination engine 122.

At least a portion of memory 204 may be considered a computer-readable medium on which computer code (e.g., instructions 210, such as may be associated with collector coordination engine 122) is stored. References to computer-readable medium, computer-readable storage medium, computer program product, tangibly embodied computer program, or the like, or a controller, circuitry, computer, processor, or the like should be understood to encompass not only computers having different architectures such as single or multi-processor architectures and sequential (Von Neumann) or parallel architectures but also specialized circuits such as FPGAs, ASICs, signal processing devices, and other devices. References to computer program, instructions, logic, code, or the like, should be understood to encompass software for a programmable processor or firmware such as, for example, the programmable content of a hardware device whether instructions for a processor, or configuration settings for a fixed-function device, gate array or programmable logic device, or the like.

Memory 204 may store collector mappings 126, shown to include collector mappings 126a through 126m. As described above, collector coordination engine 122 may store multiple collector mappings, such as different collector mappings 126 for different tenants or for any other suitable purpose. Collector mappings 126 may be referred to in the singular or the plural. In certain implementations, at least a portion of memory 204 may correspond to storage device 128 of FIG. 1 (as well as FIG. 4, below). As described above, a collector mapping 126 may indicate the data source(s) (e.g., virtualization manager(s) 110) from which a virtualization data collector 114 collects data 112 and a corresponding reporting status for each data source from which the virtualization data collector 114 collects data 112. Additional details of an example collector mapping in accordance with certain implementations are described below with reference to FIG. 5.

Interfaces 206 facilitate communication (receipt and/or transmission) of messages via one or more communication media, such as via network 106 of FIG. 1. In certain implementations, interfaces 206 include one or more ports. Interfaces 206 may facilitate communication (including transmission and/or reception) of network information 218, software update instructions 220, and/or other suitable information.

Collector coordination engine 122 may receive and transmit various communications via interfaces 206. For example, collector coordination engine 122 may receive registration information 124 from virtualization data collectors 114, operational availability information 136 from virtualization data collectors 114, and synchronization requests 132 from data consumer service 118 via interfaces 206. As another example, collector coordination engine 122 may transmit reporting instructions 130 and synchronization instructions to virtualization data collectors 114 via interfaces 206.

While FIG. 2 illustrates a particular configuration of components, this disclosure contemplates other suitable configurations. For example, although FIG. 2 shows certain components as being part of the same device, any of the components may be grouped in sets of one or more components which may exist and execute as part of any number of separate and operatively connected devices. As another example, a single component may be configured to perform all or any portion of the functionality performed by the components shown in FIG. 2. Accordingly, implementations disclosed herein should not be limited to the configuration of components shown in FIG. 2.

FIG. 3 illustrates an example signaling flow 300 for coordinating data collectors of managed computing networks, according to certain implementations. Signaling flow 300 is described using the examples of the preceding figures, but this disclosure is not limited to such implementations. In the illustrated example, signaling flow 300 involves communication between/among entities of cloud network 104 and managed network 102. For example, signaling flow 300 involves communication between/among data consumer service 118, collector coordination engine 122, a first virtualization data collector 114a (e.g., abbreviated at DC 1), a second virtualization data collector 114n (abbreviated as DC 2), and virtualization manager 110 (as an example of a data source). Furthermore, communication between entities of cloud network 104 and managed network 102 may occur over network 106. The following describes steps 1 through 21 of the example signaling flow 300 of FIG. 3.

At step 1, virtualization manager 110 may communicate with DC 1 to register with DC 1 so that DC 1 can collect data 112 from virtualization manager 110. This registration may be performed in response to DC 1 being brought online, and may performed automatically or in response to user action. This correspondence may occur via an application programing interface (API).

For example, a user may register virtualization manager 110, such as with one or more virtualization data collectors 114 (e.g., DC 1 in this example, and DC 2 at step 7, described below), through a virtualization management interface (e.g., a Desired State Configuration (DSC)-Manager interface). The user may provide credentials, such as an IP address of virtualization manager 110, hostname, username, and/or password with appropriate permissions. A data collector 114 (e.g., DC 1 in this example, and DC 2 at step 7, described below) then may attempt to establish a connection to virtualization manager 110, verifying the credentials and validating sufficient permissions to access data. Upon successful connection and validation, data collector 114 (e.g., DC 1 in this example, and DC 2 at step 7, described below) may perform an initial data collection to gather basic information about virtualization manager 110. The virtualization data collector 114 (e.g., DC 1 in this example, and DC 2 at step 7, described below) may update its internal configuration to include the newly registered virtualization manager 110, preparing for possible ongoing data collection.

At step 2, DC 1 may send registration information 124a to collector coordination engine 122. Registration information 124a may indicate that DC 1 is configured to collect data 112a from virtualization manager 110a of managed network 102 for transmission to data consumer service 118 located in cloud network 104. Registration information 124a may include some or all of the information that DC 1 learned or otherwise generated at step 1, such as information about virtualization manager 110. Collector coordination engine 122 may update collector mapping 126 according to the received registration information 124a. For example, collector coordination engine 122 may update collector mapping 126 to include a mapping between DC 1 and virtualization manager 110a.

In certain implementations, when a virtualization data collector 114 (e.g., DC 1) comes online, whether due to initial deployment, system restart, or recovery from a failure, the virtualization data collector 114 may initiate a registration process with collector coordination engine 122, such as by sending registration information 124 (e.g., registration information 124a) to collector coordination engine 122. Registration information may include, for example, an identifier for the virtualization data collector 114; identifiers for the virtualization manager(s) 110 or other data sources from which the virtualization data collector 114 is configured to collect data 112; information about the host environment of the virtualization data collector, such as its location within managed network 102; the current operational status and capabilities of the virtualization data collector 114, and/or any other suitable information. In certain implementations, communication of registration information 124 may occur through a designated messaging service or communication channel, such as a specific KAFKA topic dedicated to registration events.

Upon receiving registration information 124, collector coordination engine 122 may process the information in a suitable manner, such as by verifying the authenticity of the virtualization data collector 114, determining whether the virtualization data collector 114 is already known to collector coordination engine 122, updating collector mapping 126 (as described above), and performing other suitable operations, if applicable.

It should be noted that in certain implementations, a virtualization data collector 114 may be able to deregister from collector coordination engine 122. For example, when a virtualization data collector 114 is intentionally shut down or removed from the system, that virtualization data collector 114 may send a deregistration message to collector coordination engine 122. This deregistration process may allow collector coordination engine 122 to update collector mapping 126 and potentially reassign responsibilities to other available virtualization data collectors 114. This deregistration process also could be handled through the failover process described elsewhere in this disclosure.

At step 3, collector coordination engine 122 may determine a reporting status to assign to DC 1. For example, collector coordination engine 122 may determine whether DC 1 will have a reporting status of active or standby. This disclosure contemplates collector coordination engine 122 determining a reporting status to assign to DC 1 in any suitable manner. Based on the current state of system 100 and the newly-registered virtualization data collector 114, collector coordination engine 122 may determine a reporting status to assign to the virtualization data collector 114 (e.g., DC 1 in this example). This may involve load balancing considerations if multiple virtualization data collectors 114 are available for the same data source. Various techniques are described throughout this disclosure.

For purposes of explaining the example shown in FIG. 3, it will be assumed that collector coordination engine 122 determines that DC 1 is to have a reporting status of active in which DC 1 is to transmit data 112 collected from virtualization manager 110a to data consumer service 118. In certain implementations, in response to determining DC 1 is to transmit data 112 collected from virtualization manager 110a to data consumer service 118, collector coordination engine 122 may update collector mapping 126 to include a reporting status of active for DC 1 in association with virtualization manager 110a.

At step 4, collector coordination engine 122 transmits a reporting instruction 130 to DC 1 to configure DC 1 to have the reporting status determined at step 3. In this example, collector coordination engine 122 transmits a reporting instruction 130 to DC 1 to configure DC 1 to have a reporting status of active in which DC 1 is to transmit data 112 collected from virtualization manager 110a to data consumer service 118.

At step 5, DC 1 may collect data 112 from virtualization manager 110a, which may be an ongoing process. Although shown to begin at step 5, DC 1 may begin to collect data 112 from virtualization manager 110a at any suitable time, such as immediately after step 1 or another suitable time.

At step 6, and in accordance with the reporting instruction 130 sent by collector coordination engine 122 at step 4, DC 1 may transmit data 112 collected from virtualization manager 110a to data consumer service 118. DC 1 may transmit data 112 collected from virtualization manager 110a to data consumer service 118 when data 112 changes or at another suitable interval.

At step 7, virtualization manager 110 may correspond with DC 2 to register with DC 2 so that DC 2 can collect data 112 from virtualization manager 110. This registration may be performed in response to DC 2 being brought online, and may performed automatically or in response to user action. This correspondence may occur via an API. In certain implementations, step 7 may be performed in a similar manner to step 1 described above.

At step 8, DC 2 may send registration information 124n to collector coordination engine 122. Registration information 124n may indicate that DC 2 is configured to collect data 112a from virtualization manager 110a of managed network 102 for transmission to data consumer service 118 located in cloud network 104. Registration information 124n may include some or all of the information that DC 2 learned or otherwise generated at step 7, such as information about virtualization manager 110. Collector coordination engine 122 may update collector mapping 126 according to the received registration information 124n. For example, collector coordination engine 122 may update collector mapping 126 to include a mapping between DC 2 and virtualization manager 110a.

At step 9, collector coordination engine 122 may determine that another virtualization data collector 114 (DC 1) already is mapped to virtualization manager 110a. For example, collector coordination engine 122 may determine, according to collector mapping 126, that DC 1 is mapped to virtualization manager 110a, and in this example, has a reporting status of active.

At step 10, collector coordination engine 122 may determine a reporting status to assign to DC 2. For example, collector coordination engine 122 may determine whether DC 2 will have a reporting status of active or standby. This disclosure contemplates collector coordination engine 122 determining a reporting status to assign to DC 2 in any suitable manner. Various techniques are described throughout this disclosure.

For purposes of explaining the example shown in FIG. 3, it will be assumed that collector coordination engine 122 determines that DC 2 is to have a reporting status of standby in which DC 2 is to refrain from transmitting data 112 collected from virtualization manager 110a to data consumer service 118 (and possibly to refrain from collecting data 112 from virtualization manager 110a, depending on implementation). In certain implementations, in response to determining DC 2 is to refrain from transmitting data 112 collected from virtualization manager 110a to data consumer service 118 (and possibly to refrain from collecting data 112 from virtualization manager 110a, depending on implementation), collector coordination engine 122 may update collector mapping 126 to include a reporting status of standby for DC 2 in association with virtualization manager 110a.

At step 11, collector coordination engine 122 transmits a reporting instruction 130 to DC 2 to configure DC 2 to have the reporting status determined at step 10. In this example, collector coordination engine 122 transmits a reporting instruction 130 to DC 2 to configure DC 2 to have a reporting status of standby in which DC 2 is to refrain from transmitting data 112 collected from virtualization manager 110a to data consumer service 118 (and possibly to refrain from collecting data 112 from virtualization manager 110a, depending on implementation).

At step 12, DC 2 may collect data 112 from virtualization manager 110a, which may be an ongoing process. Although shown to begin at step 12, DC 2 may begin to collect data 112 from virtualization manager 110a at any suitable time, such as immediately after step 7 or another suitable time. In accordance with the reporting instruction 130 sent by collector coordination engine 122 at step 11, DC 2 may refrain from transmitting data 112 collected from virtualization manager 110a to data consumer service 118 (and possibly refrain from collecting data 112 from virtualization manager 110a, depending on implementation).

Steps 13-16 provide a data synchronization technique. At step 13, data consumer service 118 sends a data synchronization request 132 to collector coordination engine 122. The data synchronization request 132 could be a request to synchronize data for all data sources of data consumer service 118 or for particular data sources of data consumer service 118. For purposes of the example in FIG. 3, it will be assumed that data synchronization request 132 is a request to synchronize data for virtualization manager 110 (e.g., virtualization manager 110a of FIG. 1). Although shown at steps 13-16, in some implementations, data consumer service 118 initiates (e.g., via collector coordination engine 122) any collection and/or reporting of data that is to be transmitted to data consumer service 118 by one or more virtualization data collectors 114. For example, in such implementations, even prior to step 6 (or possibly even an earlier step), data consumer service 118 may communicate a request to collector coordination engine 122 to trigger collector coordination engine 122 to determine and configure an active data collector 114 to collect and transmit data to data consumer service 118.

At step 14, collector coordination engine 122 may determine, according to collector mapping 126, which one or more virtualization data collectors 114 (DC 1 or DC 2 in this example) are active for the applicable data sources associated with the data synchronization request 132. In this example, collector coordination engine 122 may determine, according to collector mapping 126, whether DC 1 or DC 2 is active for virtualization manager 110a, and the outcome of that determination is that DC 1 has a reporting status of active for virtualization manager 110a.

At step 15, collector coordination engine 122 may transmit an instruction 134a to DC 1 to instruct DC 1 to transmit the current version of collected data 112 to data consumer service 118. At step 16, DC 1 may transmit the current version of the data 112 collected from virtualization manager 110a to data consumer service 118.

Steps 17-21 provide a failover technique. As described above with reference to FIG. 1, collector coordination engine 122 may monitor operational statuses of virtualization data collectors 114. In this example, collector coordination engine 122 may monitor the operational statuses of DC 1 and DC 2, such as by receiving operational availability information 136 from DC 1 and DC 2.

Turning to signaling flow 300, at step 17, DC 1 may become unavailable to transmit data 112 to data consumer service 118. Example reasons why DC 1 might become unavailable are described above with reference to FIG. 1. At step 18 collector coordination engine 122 may detect that DC 1 has an operational status of unavailable. At step 19, in response to detecting at step 18 that DC 1 has an operational status of unavailable, collector coordination engine 122 may determine a particular virtualization data collector 114 to reconfigure as an active virtualization data collector 114 for virtualization manager 110a. For example, collector coordination engine 122 may determine whether one or more other virtualization data collectors 114 have a reporting status of standby for virtualization manager 110a, and select from those one or more virtualization data collectors 114 a particular virtualization data collector 114 to reconfigure to have a reporting status of active for virtualization manager 110a. In this example, collector coordination engine 122 may determine that DC 2 has a reporting status of standby for virtualization manager 110a and may determine to reconfigure DC 2 to have a reporting status of active for virtualization manager 110a.

At step 20, collector coordination engine 122 may transmit a reporting instruction 130 to DC 2 to reconfigure DC 2 to have an active reporting status for virtualization manager 110a such that DC 2 is to transmit data 112 for virtualization manager 110a to data consumer service 118. At step 21, collector coordination engine 122 may update collector mapping 126. For example, collector coordination engine 122 may update collector mapping 126 to reflect that DC 2 now has an active reporting status for virtualization manager 110a.

FIG. 4 illustrates an example system 100 for coordinating data collectors of managed computing networks, according to certain implementations. In particular, FIG. 4 illustrates an example in which a second virtualization manager 110b has been added to system 100 such that managed network 102 of system 100 in FIG. 4 includes two virtualization managers 110a and 110b. Additionally, at least two virtualization data collectors 114 (virtualization data collector 114a and virtualization data collector 114n) collect data 112 from the two virtualization managers 110a and 110b. Although FIG. 4 shows system 100 to include two virtualization managers 110, system 100 may include any suitable number of virtualization managers 110 and/or other data sources.

In certain implementations, system 100 may include multiple data sources, such as multiple virtualization managers 110a and 110b (as shown in the example of FIG. 4) and/or multiple computing clusters managed by one or more virtualization managers 110. Taking the example of FIG. 4, virtualization data collector 114a and virtualization data collector 114n are configured to collect data 112a from virtualization manager 110a, and virtualization data collector 114a and virtualization data collector 114n are configured to collect data 112b from virtualization manager 110b. In certain implementations, a virtualization data collector 114 being configured to collect data 112 from a virtualization manager 110 may include that the virtualization data collector 114 actually is collecting data 112 from a virtualization manager 110, or that the virtualization data collector 114 is capable of collecting data 112 from a virtualization manager 110 such that the virtualization data collector 114 can collect data 112 from the virtualization manager 110 in response to being configured (e.g., instructed) to do so.

Registration information 124a and 124n from virtualization data collectors 114a and 114n, respectively, may indicate the additional mapping of virtualization data collectors 114a and 114n to virtualization manager 110b. Collector coordination engine 122 may update collector mapping 126 to include the mapping between the virtualization data collector 114a and virtualization manager 110b and to include the mapping between virtualization data collector 114n and virtualization manager 110b.

In the example of FIG. 4, collector coordination engine 122 determines, according to collector mapping 126, that virtualization data collector 114a is to transmit data 112a to data consumer service 118, and may configure virtualization data collector 114a to transmit data 112a to data consumer service 118 by transmitting reporting instruction 130a to virtualization data collector 114a. Additionally, in the example of FIG. 4, collector coordination engine 122 determines, according to collector mapping 126, that virtualization data collector 114n is to transmit data 112b to data consumer service 118, and may configure virtualization data collector 114n to transmit data 112b to data consumer service 118 by transmitting reporting instruction 130n to virtualization data collector 114n.

In the example of FIG. 4, collector coordination engine 122 may determine, according to collector mapping 126, that virtualization data collector 114n (representing a virtualization data collector 114 other than virtualization data collector 114a) is to refrain from transmitting data 112a to data consumer service 118 (and possibly to refrain from collecting data 112a from virtualization manager 110a, depending on implementation), and may configure virtualization data collector 114n to refrain from transmitting data 112a to data consumer service 118 (and possibly to refrain from collecting data 112a from virtualization manager 110a, depending on implementation) by transmitting reporting instruction 130n to virtualization data collector 114n. Additionally, in the example of FIG. 4, collector coordination engine 122 may determine, according to collector mapping 126, that virtualization data collector 114a is (and possibly other virtualization data collectors 114 other than virtualization data collector 114n are) to refrain from transmitting data 112b to data consumer service 118 (and possibly to refrain from collecting data 112b from virtualization manager 110b, depending on implementation), and may configure virtualization data collector 114a to refrain from transmitting data 112b to data consumer service 118 (and possibly to refrain from collecting data 112b from virtualization manager 110b, depending on implementation) by transmitting reporting instruction 130a to virtualization data collector 114a (or a corresponding reporting instruction 130 for other virtualization data collectors 114 that collector coordination engine 122 is configuring with the standby reporting status).

Virtualization data collectors 114 may hold multiple reporting statuses for different data sources (e.g., virtualization managers 110 and/or clusters) at wholly or partially overlapping time intervals. Taking the above example related to FIG. 4, at an at least partially overlapping time interval, virtualization data collector 114a may have the first active reporting status for virtualization manager 110a and the second standby status for virtualization manager 110b, and virtualization data collector 114n may have the first standby reporting status for virtualization manager 110a and the second active reporting status for virtualization manager 110b.

In certain implementations, a virtualization manager 110 may manage multiple computing clusters of managed network 102. As just an example, virtualization manager 110 may manage a first computing cluster and a second computing cluster. Of course, a virtualization manager 110 could manage any suitable number of computing clusters. In certain implementations, computing clusters could be treated as separate data sources for which collector coordination engine 122 could assign data collectors 114 a reporting status. In this example, the first computing cluster could produce first data 112 and the second computing cluster could produce second data 112. In certain implementations, collector coordination engine 122 might determine that a particular virtualization data collector 114 is to have different reporting statuses for different computing clusters. Continuing with the above example, in certain implementations, collector coordination engine 122 may determine that a particular virtualization data collector 114 is to collect and transmit the first data for a first computing cluster to data consumer service 118 (e.g., is to have a reporting status of active), and that the particular virtualization data collector 114 is to refrain from transmitting (and possibly from collecting) the second data for a second computing cluster to data consumer service 118 (e.g., is to have a reporting status of standby). In this example, in response to these determinations, collector coordination engine 122 may conFIGURE(e.g., using a first reporting instruction) the particular virtualization data collector 114 to collect and transmit the first data 112 to data consumer service 118 and to refrain from transmitting (and possibly from collecting) the second data 112 to data consumer service 118.

FIG. 5 illustrates example collector mapping table 500, according to certain implementations. Collector mapping table 500 may be an example of collector mapping 126 of FIGS. 1 and 4. Although shown in a table format in FIG. 5, collector mapping 126 of FIGS. 1 and 4 may be stored in any suitable format/data structure. Furthermore, although particular entries (IDs, status indicators) in collector mapping table 500 are shown to be in a particular format, the entries may have any suitable format.

As shown in FIG. 5, collector mapping table includes columns 502, 504, 506, 508, and 510. Column 502 provides an identifier of a virtualization data collector 114 (abbreviated as VDC ID in the header for column 502), column 504 provides a virtualization manager ID (abbreviated as V. Manager ID in the header for column 504), column 506 provides a cluster ID, column 508 provides a reporting status, and column 510 provides an operational status. Each of these columns are described in greater detail below.

In the illustrated example, collector mapping table 500 includes entries in column 502 for virtualization data collectors 114 that have registered with collector coordination engine 122. An identifier of the virtualization data collector 114 is included in column 502 (e.g., DC1, DC2, DC3), and each virtualization data collector 114 has one or more associated rows. The number of rows for a particular virtualization data collector identified in column 502 may depend on the information for that virtualization data collector 114 provided in the remaining columns of collector mapping table 500.

Column 504 provides the virtualization managers 110 from which the virtualization data collectors 114 identified in column 502 collect data. In the illustrated example, data collectors 1 and 2 collect data from virtualization managers 1, 2, and 3, while data collector 3 collects data from virtualization managers 1 and 2.

Collector mapping table 500 also corresponds to an example in which virtualization managers 1 and 3 manage multiple computing clusters. For example, virtualization manager 1 is shown to manage computing clusters A and B, with column 506 showing 1.A or 1.B. As another example, virtualization manager 3 is shown to manage computing clusters A, B, and C, with column 506 showing 3.A, 3.B, or 3.C. Because in this example, virtualization manager 2 does not manage one or more clusters, column 506 shows not applicable (N/A) for entries corresponding to virtualization manager 2.

For each virtualization data collector 114 and associated virtualization manager 110 combination in columns 502 and 504 (and possibly further subdivided by cluster in column 506), column 508 provides the reporting status of the virtualization data collector 114. As described above, collector coordination engine 122 may determine a reporting status of the virtualization data collectors 114 that have registered with collector coordination engine 122 in relation to virtualization managers 110 (and possible computing clusters). In one example, the reporting status may be “active” or “standby,” though these are just examples.

In the illustrated example, collector coordination engine 122 has configured virtualization data collector DC1 with an “active” reporting status for computing cluster 1.A of virtualization manager 1 and computing clusters 3.B and 3.C of virtualization manager 3, and has configured virtualization data collector DC1 with a “standby” reporting status for computing cluster 1.B of virtualization manager 1, virtualization manager 2, and computing cluster 3.A of virtualization manager 3. In the illustrated example, collector coordination engine 122 has configured virtualization data collector DC2 with an “active” reporting status for computing cluster 1.B of virtualization manager 1 and computing cluster 3.A of virtualization manager 3, and has configured virtualization data collector DC2 with a “standby” reporting status for computing cluster 1.A of virtualization manager 1, virtualization manager 2, and computing clusters 3.A and 3.B of virtualization manager 3. In the illustrated example, collector coordination engine 122 has configured virtualization data collector DC3 with an “active” reporting status for virtualization manager 2, and has configured virtualization data collector DC3 with a “standby” reporting status for computing clusters 1.A and 1.B of virtualization manager 1 and computing clusters 3.A, 3.B, and 3.C of virtualization manager 3.

Column 510 provides the operational status of the virtualization data collector 114 shown in column 502. As described above, collector coordination engine 122 may monitor an operational status of the virtualization data collectors 114 that have registered with collector coordination engine 122. In one example, those operational status may be “available” or “unavailable,” though these are just examples. An operational status of “available” may mean that the virtualization data collector 114 is able to collect and transmit data to data consumer service 118, while an operational status of “unavailable” may mean that the virtualization data collector 114 is unable to collect and transmit data to data consumer service 118. This operational status may be used by collector coordination engine 122 to facilitate a failover operation if a virtualization data collector 114 with a reporting status of “active” for a particular virtualization manager 110 (and/or computer cluster) becomes unavailable. In the illustrated example, virtualization data collectors DC1, DC2, and DC3, all show an operational status of “available.”

FIGS. 6-10 illustrate various example methods according to certain implementations of this disclosure. In certain implementations, some or all of the operations associated with the methods of FIGS. 6-10 are performed by collector coordination engine 122. For example, some or all of the operations associated with the methods of FIGS. 6-10 by execution of instructions 212 (of FIG. 2) that implement collector coordination engine 122. Furthermore, the methods of FIGS. 6-10 are described using the examples of the preceding figures, but this disclosure is not limited to such implementations. One or more of the methods may be performed iteratively and/or at any point during operation of collector coordination engine 122. Although described separately, it will be understood that the operations described in association with the methods of FIGS. 6-10 may be combined in any suitable manner.

FIG. 6 illustrates an example method 600 for coordinating data collectors of managed computing networks, according to certain implementations. Example steps of method 600 are described below.

At step 602, collector coordination engine 122 may receive registration information 124a-124n from virtualization data collectors 114 (e.g., virtualization data collectors 114a-114n) that are configured to collect data 112a from virtualization manager 110a of managed network 102 for transmission to data consumer service 118 located in cloud network 104. In certain implementations, a virtualization data collector 114 being configured to collect data 112 from a virtualization manager 110 may include that the virtualization data collector 114 actually is collecting data 112 from a virtualization manager 110, or that the virtualization data collector 114 is capable of collecting data 112 from a virtualization manager 110 such that the virtualization data collector 114 can collect data 112 from the virtualization manager 110 in response to being configured (e.g., instructed) to do so. Virtualization data collectors 114a-114n may be located in managed network 102.

At step 604, collector coordination engine 122 may determine, from among virtualization data collectors 114 (e.g., virtualization data collectors 114a-114n), a particular virtualization data collector 114 to collect and transmit the data 112 to data consumer service 118 for data collected from a particular virtualization manager 110. In certain implementations, collector coordination engine 122 maintains a collector mapping 126 that maps virtualization data collectors 114 to one or more virtualization managers 110 (e.g., virtualization manager 110a of FIG. 1). In certain implementations, collector coordination engine 122 may determine, from among virtualization data collectors 114 (e.g., virtualization data collectors 114a-114n), a particular virtualization data collector 114 to collect and transmit the data 112 to data consumer service 118 according to collector mapping 126.

Collector coordination engine 122 may determine which virtualization data collector 114 will be the active virtualization data collector 114 for collecting data 112 and transmitting data 112 to data consumer service 118 in any suitable manner and according to any suitable criteria. In certain implementations, collector coordination engine 122 may determine which virtualization data collector 114 will be the active virtualization data collector 114 for collecting data 112 and transmitting data 112 to data consumer service 118 according to load balancing considerations. In the example of method 600, collector coordination engine 122 may determine that the particular virtualization data collector 114 is to collect data 112 and transmit data 112 to data consumer service 118 by determining, according to load balancing considerations, that the particular virtualization data collector 114 is to collect data 112 and transmit data 112 to data consumer service 118.

In certain implementations, in response to determining the particular virtualization data collector 114 is to collect the data 112 and transmit the data 112 to data consumer service 118, collector coordination engine 122 may update collector mapping 126 to include an active reporting status for the particular virtualization data collector 114 in association with the first virtualization manager 110. In certain implementations, in association with determining that the particular virtualization data collector 114 is to collect the data 112 and transmit the data 112 to data consumer service 118, collector coordination engine 122 also may determine that one or more other virtualization data collectors 114 are to refrain from transmitting the data 112 to data consumer service 118, and possibly are to refrain from even collecting the data 112 from the first virtualization manager 110. Collector coordination engine 122 may update collector mapping 126 to include a standby reporting status for the other virtualization data collectors 114 in association with virtualization manager 110a.

At step 606, collector coordination engine 122 may configure the particular virtualization data collector 114 to transmit the data 112 to data consumer service 118. In certain implementations, to configure the particular virtualization data collector 114 to transmit data 112 to data consumer service 118, collector coordination engine 122 may transmit a first reporting instruction 130 to the particular virtualization data collector 114 to cause the particular virtualization data collector 114 to transmit data 112 to data consumer service 118. In certain implementations, as described above with reference to FIG. 1, configuring the particular virtualization data collector 114 to transmit the data 112 to data consumer service 118 may include configuring the particular virtualization data collector 114 to collect the data 112 from the first virtualization manager 110, and the first reporting instruction 130 may include an instruction for the particular virtualization data collector 114 to collect the data 112 from the first virtualization manager 110, if appropriate. In the example of FIG. 1, collector coordination engine 122 determines, according to collector mapping 126, that virtualization data collector 114a is to transmit data 112a to data consumer service 118, and may configure virtualization data collector 114a to transmit data 112a to data consumer service 118 by transmitting reporting instruction 130a to virtualization data collector 114a.

At step 608, collector coordination engine 122 may configure other virtualization data collectors 114 to refrain from transmitting the first data 112 to data consumer service 118. For example, collector coordination engine 122 may configure other virtualization data collectors 114 of virtualization data collectors 114a-114n, other than the particular virtualization data collector 114 determined at step 604 to be the active virtualization data collector 114, to refrain from transmitting data 112 to data consumer service 118. In certain implementations, to configure the other virtualization data collectors 114 to refrain from transmitting data 112 to data consumer service 118, collector coordination engine 122 may transmit second reporting instructions 130 to the other virtualization data collectors 114 to cause the other virtualization data collectors 114 to refrain from transmitting data 112 to data consumer service 118. In certain implementations, as described above with reference to FIG. 1, configuring other virtualization data collectors 114 of virtualization data collectors 114a-114n, other than the particular virtualization data collector 114 determined at step 604 to be the active virtualization data collector 114, to have a standby reporting status may include configuring the other virtualization data collectors 114 of virtualization data collectors 114a-114n to refrain from collecting data 112 from the first virtualization manager 110, and the second reporting instructions 130 may include an instruction for the other virtualization data collectors 114 of virtualization data collectors 114a-114n to refrain from collecting data 112 from the first virtualization manager 110, if appropriate. In the example of FIG. 1, collector coordination engine 122 determines, according to collector mapping 126, that virtualization data collectors 114 other than virtualization data collector 114a (e.g., represented as virtualization data collector 114n) are to refrain from transmitting data 112a to data consumer service 118, and may configure virtualization data collector 114n to refrain from transmitting data 112a to data consumer service 118 by transmitting reporting instruction 130n to virtualization data collector 114n (or a corresponding reporting instruction 130 for other virtualization data collectors 114 that collector coordination engine 122 is configuring with the standby reporting status).

In certain implementations, system 100 may include multiple data sources, such as multiple virtualization managers 110a and 110b (as shown in the example of FIG. 4) and/or multiple computing clusters managed by one or more virtualization managers 110. Taking the example of FIG. 4, virtualization data collector 114a and virtualization data collector 114n are configured to collect data 112a from virtualization manager 110a, and virtualization data collector 114a and virtualization data collector 114n are configured to collect data 112b from virtualization manager 110b.

In the example of FIG. 4, collector coordination engine 122 determines, according to collector mapping 126, that virtualization data collector 114a is to collect data 112a from virtualization manager 110a and to transmit data 112a to data consumer service 118, and may configure virtualization data collector 114a to collect data 112a from virtualization manager 110a and to transmit data 112a to data consumer service 118 by transmitting reporting instruction 130a to virtualization data collector 114a. Additionally, in the example of FIG. 4, collector coordination engine 122 determines, according to collector mapping 126, that virtualization data collector 114n is to collect data 112b from virtualization manager 110b and to transmit data 112b to data consumer service 118, and may configure virtualization data collector 114n to collect data 112b from virtualization manager 110b and to transmit data 112b to data consumer service 118 by transmitting reporting instruction 130n to virtualization data collector 114n.

In the example of FIG. 4, collector coordination engine 122 may determine, according to collector mapping 126, that virtualization data collector 114n (representing a virtualization data collector 114 other than virtualization data collector 114a) is to refrain from transmitting data 112a to data consumer service 118 (and possibly to refrain from collecting data 112a from virtualization manager 110a, depending on implementation), and may configure virtualization data collector 114n to refrain from transmitting data 112a to data consumer service 118 by transmitting reporting instruction 130n to virtualization data collector 114n. Additionally, in the example of FIG. 4, collector coordination engine 122 may determine, according to collector mapping 126, that virtualization data collector 114a is (and possibly other virtualization data collectors 114 other than virtualization data collector 114n are) to refrain from transmitting data 112b to data consumer service 118 (and possibly to refrain from collecting data 112b from virtualization manager 110b, depending on implementation), and may configure virtualization data collector 114a to refrain from transmitting data 112b to data consumer service 118 by transmitting reporting instruction 130a to virtualization data collector 114a (or a corresponding reporting instruction 130 for other virtualization data collectors 114 that collector coordination engine 122 is configuring with the standby reporting status).

In certain implementations, a virtualization manager 110 may manage multiple computing clusters of managed network 102. As just an example, virtualization manager 110 may manage a first computing cluster and a second computing cluster. Of course, a virtualization manager 110 could manage any suitable number of computing clusters. In certain implementations, computing clusters could be treated as separate data sources for which collector coordination engine 122 could assign data collectors 114 a reporting status. In this example, the first computing cluster could produce first data 112 and the second computing cluster could produce second data 112. In certain implementations, collector coordination engine 122 might determine that a particular virtualization data collector 114 is to have different reporting statuses for different computing clusters. Continuing with the above example, in certain implementations, collector coordination engine 122 may determine that a particular virtualization data collector 114 is to collect and transmit the first data for a first computing cluster to data consumer service 118 (e.g., is to have a reporting status of active), and that the particular virtualization data collector 114 is to refrain from transmitting the second data for a second computing cluster to data consumer service 118 (e.g., is to have a reporting status of standby). In this example, in response to these determinations, collector coordination engine 122 may conFIGURE(e.g., using a first reporting instruction) the particular virtualization data collector 114 to transmit the first data 112 to data consumer service 118 and to refrain from transmitting the second data 112 to data consumer service 118 (and possibly to refrain from collecting the second data 112).

As described above, in certain implementations, collector coordination engine 122 may employ load balancing techniques when determining which virtualization data collectors 114 to configure with an active reporting status for particular data sources (e.g., virtualization managers 110 and/or computing clusters). To implement load balancing, collector coordination engine 122 may consider one or more factors to optimize the distribution of data reporting tasks (e.g., reporting collected data 112 to a data consumer service 118) among available virtualization data collectors 114.

For example, in a scenario in which multiple virtualization data collectors 114 are mapped to a same data source (e.g., virtualization manager 110), collector coordination engine 122 may assign different virtualization data collectors 114 to collect data 112 from different computing clusters within the environment managed by that virtualization manager 110. This granular reporting status assignment may allow for more efficient use of resources and may reduce or eliminate instances of a single virtualization data collector 114 becoming overburdened.

Collector coordination engine 122 may consider the activity levels of different computing clusters when making these reporting status assignments. For instance, if a particular computing cluster is known to be very active, generating a high volume of data 112 or data 112 that frequently changes, collector coordination engine 122 may dedicate a specific virtualization data collector 114 to that computing cluster. Conversely, multiple less active computing clusters might be assigned to a single virtualization data collector 114.

Furthermore, collector coordination engine 122 may dynamically adjust these reporting status assignments based on observed performance and changing conditions. If a particular virtualization data collector 114 is found to be consistently under high load, collector coordination engine 122 may redistribute some of its assigned computing clusters (and/or other data sources) to other, less burdened virtualization data collectors 114. Thus, it should be noted that in certain implementations, the trigger for assigning reporting statuses to virtualization data collectors 114 might be changed performance characteristics, load statuses, or other factors, in addition to and/or instead of a new virtualization data collector 114 being brought online and sending associated registration information 124.

This load balancing approach may apply to scenarios involving multiple virtualization managers 110. Collector coordination engine 122 may strive to distribute the active reporting responsibilities across different virtualization data collectors 114 for different virtualization managers 110, reducing or eliminating instances in which a single virtualization data collector 114 is responsible for collecting data 112 from too many data sources simultaneously.

In certain implementations, by implementing load balancing techniques, system 100 may maintain improved performance, facilitate timely data collection and transmission (e.g., to data consumer service 118), and make efficient use of the available virtualization data collectors 114, potentially contributing to a more robust and responsive cloud-based management environment.

To configure a virtualization data collector 114 to have an active reporting status for transmitting data 112 to data consumer service 118, collector coordination engine 122 might or might not transmit a reporting instruction 130 to the virtualization data collector 114 that collector coordination engine 122 determined to have an active reporting status, depending on implementation. For example, the default behavior of virtualization data collectors 114 may be to collect data from associated data sources and to report collected data 112 to data consumer service 118. In certain implementations, it may be possible for collector coordination engine 122 to transmit reporting instructions 130 to those virtualization data collectors 114 that collector coordination engine 122 determines to have a reporting status of standby (e.g., to refrain from transmitting data 112 to data consumer service 118. As another example, a particular virtualization data collector 114 may already have a reporting status of active for a particular data source at a time when collector coordination engine 122 receives registration information 124 for another virtualization data collector 114 and makes an associated determination, based on the received registration information 124, of which virtualization data collector 114 will have a reporting status of active for a particular data source. While it is possible that collector coordination engine 122 may determine that the new virtualization data collector 114 (from which registration information 124 was received) will become the active virtualization data collector 114 for the particular data source (e.g., due to load balancing considerations), collector coordination engine 122 may simply allow the particular virtualization data collector 114 to remain the active virtualization data collector 114 for the particular data source, with or without transmitting a new reporting instruction 130 to the particular virtualization data collector 114. Thus, in certain implementations, configuring a virtualization data collector 114 to transmit data 112 to data consumer service 118 (e.g., to have a reporting status of active) may include allowing a virtualization data collector 114 to continue to transmit data 112 to data consumer service 118 without sending a reporting instruction 130.

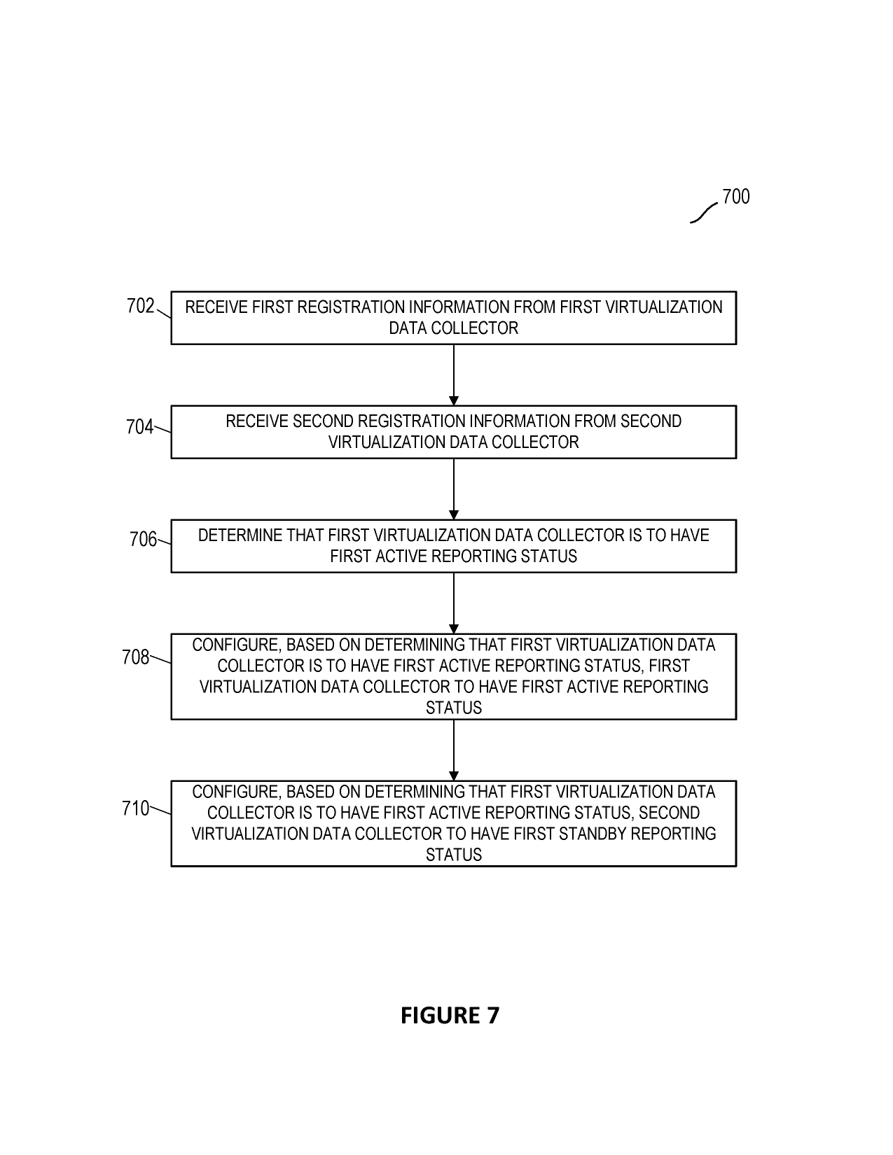

FIG. 7 illustrates an example method 700 for coordinating data collectors of managed computing networks, according to certain implementations. Example steps of method 700 are described below.

At step 702, collector coordination engine 122 may receive first registration information 124a from a first virtualization data collector 114a that is configured to collect data 112a from first virtualization manager 110a of managed network 102 for transmission to data consumer service 118 located in cloud network 104. Managed network 102 may be an on-premises computing environment that is remote from the computer system on which collector coordination engine 122 operates (e.g., computer system 200, located in cloud network 104. As described above, collector coordination engine 122 may maintain a collector mapping 126. Collector coordination engine 122 may update collector mapping 126 according to the received first registration information 124a in the manner described above. For example, collector coordination engine 122 may update collector mapping 126 to include a first mapping between the first virtualization data collector 114a and the first virtualization manager 110a.

At step 704, collector coordination engine 122 may receive second registration information 124n from a second virtualization data collector 114n that is configured to collect second data 112a from the first virtualization manager 110a of managed network 102 for transmission to data consumer service 118. Collector coordination engine 122 may update collector mapping 126 according to the received second registration information 124n in the manner described above. For example, collector coordination engine 122 may update collector mapping 126 to include a second mapping between the second virtualization data collector 114n and the first virtualization manager 110a. The first data 112a and the second data 112a may be partially or entirely duplicative. Virtualization data collectors 114a and 114n may be located in managed network 102.

In certain implementations, a virtualization data collector 114 being configured to collect data 112 from a virtualization manager 110 may include that the virtualization data collector 114 actually is collecting data 112 from a virtualization manager 110, or that the virtualization data collector 114 is capable of collecting data 112 from a virtualization manager 110 such that the virtualization data collector 114 can collect data 112 from the virtualization manager 110 in response to being configured (e.g., instructed) to do so.

At step 706, collector coordination engine 122 may determine that the first virtualization data collector 114a is to have a first active reporting status in which the first virtualization data collector 114a is to collect and transmit the first data 112a to data consumer service 118 for data collected from virtualization manager 110a. In certain implementations, collector coordination engine 122 may determine that the first virtualization data collector 114a is to collect and transmit the first data 112a to data consumer service 118 according to collector mapping 126. In certain implementations, in response to determining the first virtualization data collector 114a is to collect and transmit the data 112a to data consumer service 118, collector coordination engine 122 may update collector mapping 126 to include an active reporting status for the first virtualization data collector 114a in association with the first virtualization manager 110a. In certain implementations, in association with determining the first virtualization data collector 114a is to collect and transmit the data 112a to data consumer service 118, collector coordination engine 122 also may determine that second virtualization data collector 114n is to have a first standby reporting status in which the second virtualization data collector 114n is to refrain from transmitting the second data 112a to data consumer service 118, and possibly is to refrain from even collecting the second data 112a from virtualization manager 110a. Collector coordination engine 122 may update collector mapping 126 to include a standby reporting status for the second virtualization data collector 114n in association with the first virtualization manager 110a.

Collector coordination engine 122 may determine that the first virtualization data collector 114a will be the active virtualization data collector 114 for collecting first data 112a from virtualization manager 110a and transmitting first data 112a to data consumer service 118 in any suitable manner and according to any suitable criteria. In certain implementations, collector coordination engine 122 may determine that first virtualization data collector 114a will be the active virtualization data collector 114 for collecting first data 112a from virtualization manager 110a and transmitting first data 112a to data consumer service 118 according to load balancing considerations. In the example of method 700, collector coordination engine 122 may determine that the first virtualization data collector 114a is to collect first data 112a from virtualization manager 110a and transmit the first data 112a to data consumer service 118 by determining, according to load balancing considerations, that the first virtualization data collector 114a is to transmit the first data 112a to data consumer service 118.

At step 708, based on determining that the first virtualization data collector 114a is to have the first active reporting status, collector coordination engine 122 may configure the first virtualization data collector 114a to have the first active reporting status to collect first data 112a from virtualization manager 110a and transmit the first data 112a to data consumer service 118. In certain implementations, to configure the first virtualization data collector 114a to collect first data 112a from virtualization manager 110a and transmit the first data 112a to data consumer service 118, collector coordination engine 122 may transmit a first reporting instruction 130a to the first virtualization data collector 114a to cause the first virtualization data collector 114a to have the first active reporting status to transmit the first data 112a to data consumer service 118.

At step 710, based on determining that the first virtualization data collector 114a is to have the first active reporting status, collector coordination engine 122 may configure the second virtualization data collector 114n to have the first standby reporting status in which the second virtualization data collector 114n is to refrain from transmitting the second data 112a to data consumer service 118, and possibly is to refrain from even collecting the second data 112a from virtualization manager 110a. In certain implementations, to configure the second virtualization data collector 114n to have the first standby reporting status, collector coordination engine 122 may transmit a second reporting instruction 130n to the second virtualization data collector 114n to cause the second virtualization data collector 114n to refrain from transmitting the second data 112a to data consumer service 118, and possibly is to refrain from even collecting the second data 112a from virtualization manager 110a.

In certain implementations, system 100 may include multiple data sources, such as multiple virtualization managers 110a and 110b (as shown in the example of FIG. 4) and/or multiple computing clusters managed by one or more virtualization managers 110. Taking the example of FIG. 4, virtualization data collector 114a and virtualization data collector 114n are configured to collect first data 112a and second data 112a, respectively, from virtualization manager 110a, and virtualization data collector 114a and virtualization data collector 114n are configured to collect third data 112b and fourth data 112b, respectively, from virtualization manager 110b. Collector coordination engine 122 may update collector mapping 126 to include a third mapping between the first virtualization data collector 114a and second virtualization manager 110b and to include a fourth mapping between second virtualization data collector 114n and the second virtualization manager 110b. The third data 112b and the fourth data 112b may be partially or entirely duplicative.

In the example of FIG. 4, collector coordination engine 122 determines, according to collector mapping 126, that virtualization data collector 114a is to collect first data 112a from virtualization manager 110a and transmit first data 112a to data consumer service 118, and may configure virtualization data collector 114a to collect first data 112a from virtualization manager 110a and transmit first data 112a to data consumer service 118 by transmitting reporting instruction 130a to virtualization data collector 114a. Additionally, in the example of FIG. 4, collector coordination engine 122 determines, according to collector mapping 126, that virtualization data collector 114n is to collect fourth data 112b from virtualization manager 110b and transmit fourth data 112b to data consumer service 118, and may configure virtualization data collector 114n to collect fourth data 112b from virtualization manager 110b and transmit fourth data 112b to data consumer service 118 by transmitting reporting instruction 130n to virtualization data collector 114n.

In the example of FIG. 4, collector coordination engine 122 may determine, according to collector mapping 126, that virtualization data collector 114n (representing a virtualization data collector 114 other than virtualization data collector 114a) is to refrain from transmitting second data 112a to data consumer service 118 (and possibly to refrain from collecting second data 112a from virtualization manager 110a, depending on implementation), and may configure virtualization data collector 114n to refrain from transmitting second data 112a to data consumer service 118 (and possibly to refrain from collecting second data 112a from virtualization manager 110a, depending on implementation) by transmitting reporting instruction 130n to virtualization data collector 114n. Additionally, in the example of FIG. 4, collector coordination engine 122 may determine, according to collector mapping 126, that virtualization data collector 114a is (and possibly other virtualization data collectors 114 other than virtualization data collector 114n are) to refrain from transmitting third data 112b to data consumer service 118 (and possibly to refrain from collecting third data 112b from virtualization manager 110b, depending on implementation), and may configure virtualization data collector 114a to refrain from transmitting third data 112b to data consumer service 118 (and possibly to refrain from collecting third data 112b from virtualization manager 110b, depending on implementation) by transmitting reporting instruction 130a to virtualization data collector 114a (or a corresponding reporting instruction 130 for other virtualization data collectors 114 that collector coordination engine 122 is configuring with the standby reporting status).

Virtualization data collectors 114 may hold multiple reporting statuses for different data sources (e.g., virtualization managers 110 and/or clusters) at wholly or partially overlapping time intervals. Taking the above example related to FIG. 4, at an at least partially overlapping time interval, virtualization data collector 114a may have the first active reporting status for virtualization manager 110a and the second standby status for virtualization manager 110b, and virtualization data collector 114n may have the first standby reporting status for virtualization manager 110a and the second active reporting status for virtualization manager 110b.

In certain implementations, a virtualization manager 110 may manage multiple computing clusters of managed network 102. An example of a scenario in which collector coordination engine 122 assigns reporting statuses to virtualization data collectors 114 for different computing clusters is described above with reference to method 600 of FIG. 6.

Additionally, as described above with reference to method 600 of FIG. 6, to configure a virtualization data collector 114 to have an active reporting status for transmitting data 112 to data consumer service 118, collector coordination engine 122 might or might not transmit a reporting instruction 130 to the virtualization data collector 114 that collector coordination engine 122 determined to have an active reporting status, depending on implementation. Thus, in certain implementations, configuring a virtualization data collector 114 to transmit data 112 to data consumer service 118 (e.g., to have a reporting status of active) may include allowing a virtualization data collector 114 to continue to transmit data 112 to data consumer service 118 without sending a reporting instruction 130.

As new virtualization data collectors 114 come online, the new virtualization data collectors 114 may transmit registration information 124 to collector coordination engine 122 and collector coordination engine 122 may update collector mapping 126 accordingly. If appropriate, collector coordination engine 122 also may determine a reporting status for the new virtualization data collectors 114, which also may include reevaluating the reporting status of existing virtualization data collectors 114 that already have a reporting status. A reevaluation could be performed for any suitable reason, such as to perform load balancing among the virtualization data collectors 114 and/or to provide a backup virtualization data collector 114 for a particular data source so that a failover operation could be performed.

Taking the example of FIG. 1 or FIG. 4, collector coordination engine 122 may receive third registration information 124 from a third virtualization data collector 114 that is configured to collect third data 112a from the first virtualization manager 110a. The third data 112a may be at least partially duplicative of the first data 112a and the second data 112a. Collector coordination engine 122 may update collector mapping 126 according to the received third registration information 124 in the manner described above. For example, collector coordination engine 122 may update collector mapping 126 to include a mapping between the third virtualization data collector 114 and the first virtualization manager 110a.

In response to the third registration information 124, collector coordination engine 122 may determine that the third virtualization data collector 114 is to have an active reporting status in which the third virtualization data collector 114 is to collect third data 112a from virtualization manager 110a and transmit the third data 112a to data consumer service 118 and may configure the third virtualization data collector 114 to have the active reporting status. Based at least in part on the determination that the third virtualization data collector 114 is to have an active reporting status in which the third virtualization data collector 114 is to collect third data 112a from virtualization manager 110a and transmit the third data 112a to data consumer service 118, collector coordination engine 122 may configure the first virtualization data collector 114a to have a standby reporting status in which the first virtualization data collector 114a refrains from transmitting the first data 112a to data consumer service 118 (and possibly refrains from collecting first data 112a from virtualization manager 110a, depending on implementation) and may configure the second virtualization data collector 114n to maintain the first standby reporting status in which second virtualization data collector 114n refrains from transmitting the second data 112a to data consumer service 118 (and possibly refrains from collecting second data 112a from virtualization manager 110a, depending on implementation).

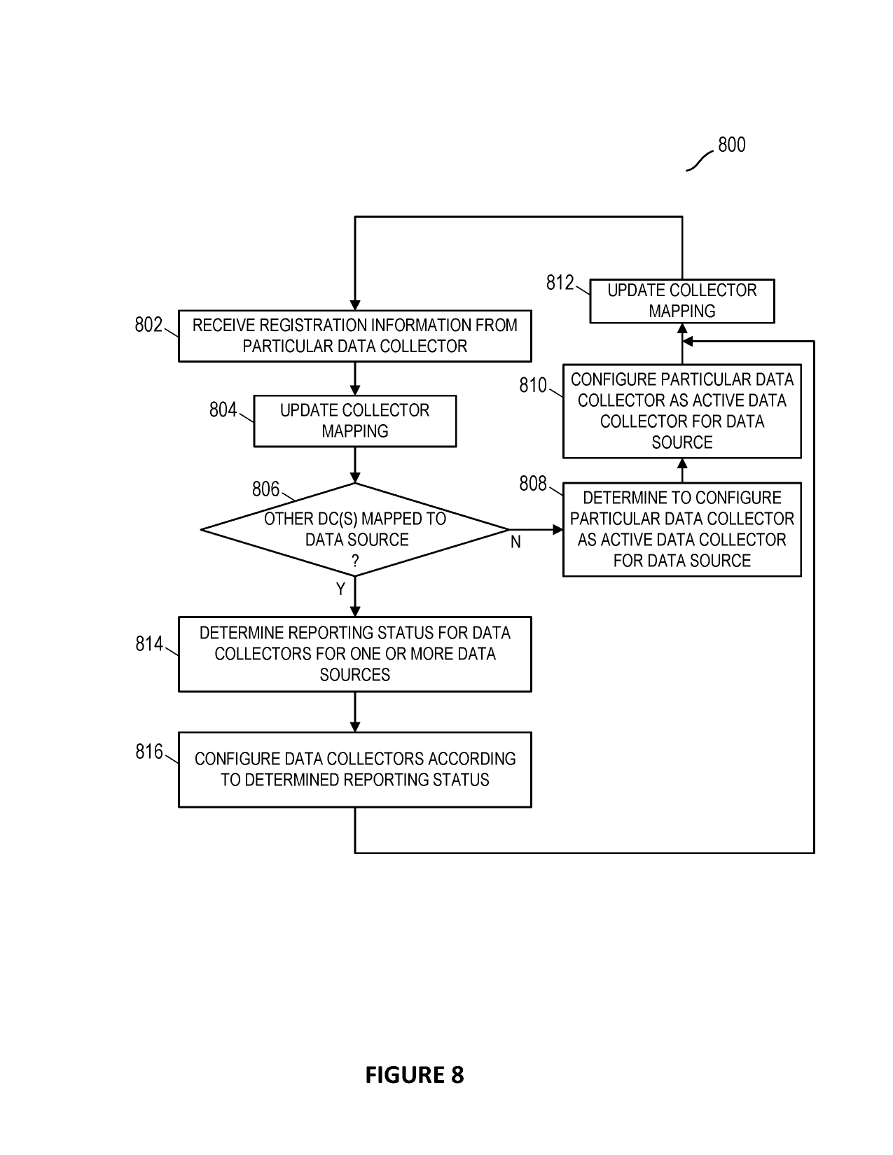

FIG. 8 illustrates an example method 800 for coordinating data collectors of managed computing networks, according to certain implementations. Example steps of method 800 are described below.

At step 802, collector coordination engine 122 may receive registration information 124 from a particular virtualization data collector 114 that is configured to collect data 112a from a particular data source of managed network 102 for transmission to data consumer service 118 located in cloud network 104. An example of the particular data source may be virtualization manager 110a. In certain implementations, a virtualization data collector 114 being configured to collect data 112 from a virtualization manager 110 may include that the virtualization data collector 114 actually is collecting data 112 from a virtualization manager 110, or that the virtualization data collector 114 is capable of collecting data 112 from a virtualization manager 110 such that the virtualization data collector 114 can collect data 112 from the virtualization manager 110 in response to being configured (e.g., instructed) to do so. Virtualization data collector 114 may be located in managed network 102.

At step 804, collector coordination engine 122 may update collector mapping 126 according to the received registration information 124 in the manner described above. For example, collector coordination engine 122 may update collector mapping 126 to include a mapping between the particular virtualization data collector 114 and the particular data source.

At step 806, collector coordination engine 122 may determine whether one or more other virtualization data collectors 114 are mapped to the particular data source. For example, collector coordination engine 122 may access collector mapping 126 to determine whether one or more other virtualization data collectors 114 are mapped to the particular data source. A virtualization data collector 114 being mapped to a data source may indicate that the virtualization data collector 114 collects data 112 from that data source and could transmit that data 112 to data consumer service 118.

If collector coordination engine 122 determines at step 806 that no other available virtualization data collectors 114 are mapped to the particular data source, then at step 808, collector coordination engine 122 may determine to configure the particular virtualization data collector 114 as having, for the particular data source, an active reporting status in which the particular virtualization data collector 114 is to transmit the data 112 from the particular data source to data consumer service 118. In certain implementations, in response to determining that the particular virtualization data collector 114 is to transmit the data 112 from the particular data source to data consumer service 118, collector coordination engine 122 may update collector mapping 126 to include an active reporting status for the particular virtualization data collector 114 in association with the particular data source.

At step 810, collector coordination engine 122 may configure the particular virtualization data collector 114 to have an reporting status of active, so that the particular virtualization data collector 114 is to transmit the data 112 from the particular data source to data consumer service 118. In certain implementations, to configure the particular virtualization data collector 114 to transmit data 112 to data consumer service 118, collector coordination engine 122 may transmit a reporting instruction 130 to the particular virtualization data collector 114 to cause the particular virtualization data collector 114 to transmit data 112 from the particular data source to data consumer service 118.

At step 812, collector coordination engine 122 may update collector mapping 126 to include an active reporting status for the particular virtualization data collector 114 in association with the particular data source. Method 800 may return to step 802 to await additional registration information 124 (e.g. changed registration information 124 from the particular virtualization data collector 114 and/or registration information 124 for another virtualization data collector 114).

Returning to step 806, if collector coordination engine 122 determines at step 806 that one or more other available virtualization data collectors 114 are mapped to the particular data source, then at step 814, collector coordination engine 122 may determine a reporting status for one or more virtualization data collectors 114 for one or more data sources. For example, in some scenarios, at least one of the other virtualization data collectors 114 that are mapped to the particular data source already is configured to have an active reporting status for the particular data source. In such a scenario, collector coordination engine 122 may simply determine that the particular virtualization data collector 114 will have a standby reporting status for the particular data source. As another example, considering the addition of the particular virtualization data collector 114, collector coordination engine 122 may analyze the reporting status of the particular virtualization data collector 114 and the other available virtualization data collectors 114 that are mapped to the particular data source to determine appropriate reporting statuses for the particular virtualization data collector 114 and the other available virtualization data collectors 114. This analysis may involve any suitable factors, such as load balancing considerations or other considerations. As another example, considering the addition of the particular virtualization data collector 114, collector coordination engine 122 may analyze the reporting status of the particular virtualization data collector 114, the other available virtualization data collectors 114 that are mapped to the particular data source, and other virtualization data collectors 114 that may be mapped to other data sources to determine appropriate reporting statuses for the particular virtualization data collector 114 and the various other virtualization data collectors 114. Similarly, this analysis may involve any suitable factors, such as load balancing considerations or other considerations.

At step 816, collector coordination engine 122 may configure the one or more virtualization data collectors 114 according to the determinations from step 814. For example, collector coordination engine 122 may send respective reporting instructions 130 to the one or more virtualization data collectors 114, as may be appropriate for a particular implementation. For example, collector coordination engine 122 may send a reporting instruction 130 to the particular virtualization data collector 114 and potentially may send respective reporting instructions 130 to one or more other virtualization data collectors 114 to configured the particular virtualization data collector 114 and the one or more other virtualization data collectors 114 to have a reporting status of active or standby. Method 800 may then proceed to step 812.

At step 812, collector coordination engine 122 may update collector mapping 126 to include the reporting statuses (e.g., active or passive) according to the determinations and configurations of steps 814 and 816. Method 800 may return to step 802 to await additional registration information 124 (e.g. changed registration information 124 from the particular virtualization data collector 114 and/or registration information 124 for another virtualization data collector 114).

FIG. 9 illustrates an example method 900 for data synchronization, according to certain implementations. Example steps of method 900 are described below.

At step 902, collector coordination engine 122 receives a request for data synchronization (e.g., data synchronization request 132 from FIGS. 1 and 4) from data consumer service 118. The request for data synchronization could be a request to synchronize data for all data sources of data consumer service 118 or for particular data sources of data consumer service 118.

At step 904, collector coordination engine 122 may determine, according to collector mapping 126, which one or more virtualization data collectors 114 are active for the applicable data sources associated with the request for data synchronization.

At step 906, collector coordination engine 122 may transmit an instruction 134 (e.g., instruction 134a through 134n, corresponding to the determined one or more virtualization data collectors 114) to the determined one or more virtualization data collectors 114 (e.g., instruction 134a through 134n, corresponding to the determined one or more virtualization data collectors 114). The instructions may instruct the one or more virtualization data collectors 114 to transmit the current version of collected data 112 to data consumer service 118.

In some scenarios, virtualization data collectors 114 are configured to transmit data 112 to data consumer service 118 when the data 112 changes or at another suitable interval. Method 900 provides a technique for data consumer service 118 to request a synchronization of data 112 with virtualization data collectors 114. Due to the features provided by collector coordination engine 122, it may be possible for data consumer service 118 to receive the data 112 from the one or more virtualization data collectors 114 that have been designated as active for the particular data sources rather than from all virtualization data collectors 114 that may be collecting the data 112 from those particular data sources, which may provide more efficient use of processing, storage, and networking resources.

FIG. 10 illustrates an example method 1000 for handling a data collectors failover, according to certain implementations. Example steps of method 1000 are described below.

At step 1002, collector coordination engine 122 may monitor operational statuses of virtualization data collectors 114. In certain implementations, collector coordination engine 122 may receive operational availability information 136 from virtualization data collectors 114. In the illustrated example of FIGS. 1 and 4, collector coordination engine 122 may receive operational availability information 136a through 136n from virtualization data collectors 114a through 114n, which may be referred to generally as operational availability information 136. Operational availability information 136 may include a heartbeat associated with virtualization data collectors 114 and/or any other suitable information that may assist collector coordination engine 122 in determining an operational status of virtualization data collectors 114.

At step 1004, collector coordination engine 122 may detect that a particular virtualization data collector that has an active status for at least one data source has an operational status of unavailable. Taking the example of FIG. 1, at a time when virtualization data collector 114a has a reporting status of active for virtualization manager 110a (e.g., is to transmit data 112a to data consumer service 118), collector coordination engine 122 may detect that virtualization data collector 114a has an operational status of unavailable.

At step 1006, in response to detecting at step 1004 that the particular virtualization data collector 114 has an operational status of unavailable, collector coordination engine 122 may determine the data sources for which the particular virtualization data collector 114 has a reporting status of active. For example, collector coordination engine 122 may determine, according to collector mapping 126, the data sources for which the particular virtualization data collector 114 has a reporting status of active. Because the current active virtualization data collector 114 for those data sources is unavailable, it may be appropriate to designate a new active virtualization data collector 114 for those data sources.

At step 1008, for each of the data sources identified at step 1006, collector coordination engine 122 may determine whether another virtualization data collector 114 has a reporting status of standby. Step 1008 and its associated outcomes may be repeated for each data source identified at step 1006.

If collector coordination engine 122 determines at step 1008 that no virtualization data collector 114 having a reporting status of standby is available for a particular data source, then for that data source, method 1000 may proceed to step 1010 at which collector coordination engine 122 may generate an alert. The alert may be transmitted to any suitable destination, such as a management dashboard for a portion or all of system 100 and/or a user. The alert may notify a recipient that a particular data source currently does not have a virtualization data collector 114 transmitting data 112 from that data source to data consumer service 118. Additionally or alternatively, collector coordination engine 122 may be configured to automatically reconfigure virtualization data collectors 114 so that the data source that lacks an active virtualization data collector 114 receives an active virtualization data collector 114 (and possibly a standby virtualization data collector 114, as well). Following step 1010, method 1000 may proceed to step 1016. At step 1016, collector coordination engine 122 may update collector mapping 126. For example, collector coordination engine 122 may update collector mapping 126 to reflect that the particular virtualization data collector 114 is now unavailable and now has a standby reporting status for the particular data source.

Returning to step 1008, if collector coordination engine 122 determines at step 1008 that at least one virtualization data collector 114 having a reporting status of standby is available for a particular data source, then for that data source, method 1000 may proceed to step 1012 at which collector coordination engine 122 may determine, from the virtualization data collectors 114 identified at step 1008, a particular virtualization data collector 114 to reconfigure as an active virtualization data collector 114 for that data source. At step 1014, collector coordination engine 122 may reconfigure the particular virtualization data collector 114 determined at step 1012 to have an active reporting status for that data source such that the particular virtualization data collector 114 is to transmit data 112 for that data source to data consumer service 118. At step 1016, collector coordination engine 122 may update collector mapping 126. For example, collector coordination engine 122 may update collector mapping 126 to reflect that the particular virtualization data collector 114 reconfigured at step 1014 now has an active reporting status for that data source. Collector coordination engine 122 may update collector mapping 126 with additional changes (other changes to reporting statuses of other virtualization data collectors 114 that may have resulted in the designation of the particular virtualization data collector 114 determined at step 1012 as the active virtualization data collector 114 for that data source), if appropriate. Method 1000 may proceed to step 1018.

At step 1018, collector coordination engine 122 may determine whether another data source exists for which the determination at step 1008 has yet to be made. If collector coordination engine 122 determines at step 1018 that another data source exists, then method 1000 may return to step 1008 to address the next data source. If collector coordination engine 122 determines at step 1018 that no other data sources remain, then method 1000 may return to step 1002 to continue monitoring the operational statuses of virtualization data collectors 114. Of course, it will be understood that in certain implementations, collector coordination engine 122 may monitor the operational statuses of virtualization data collectors 114 substantially continuously or at any other suitable interval.

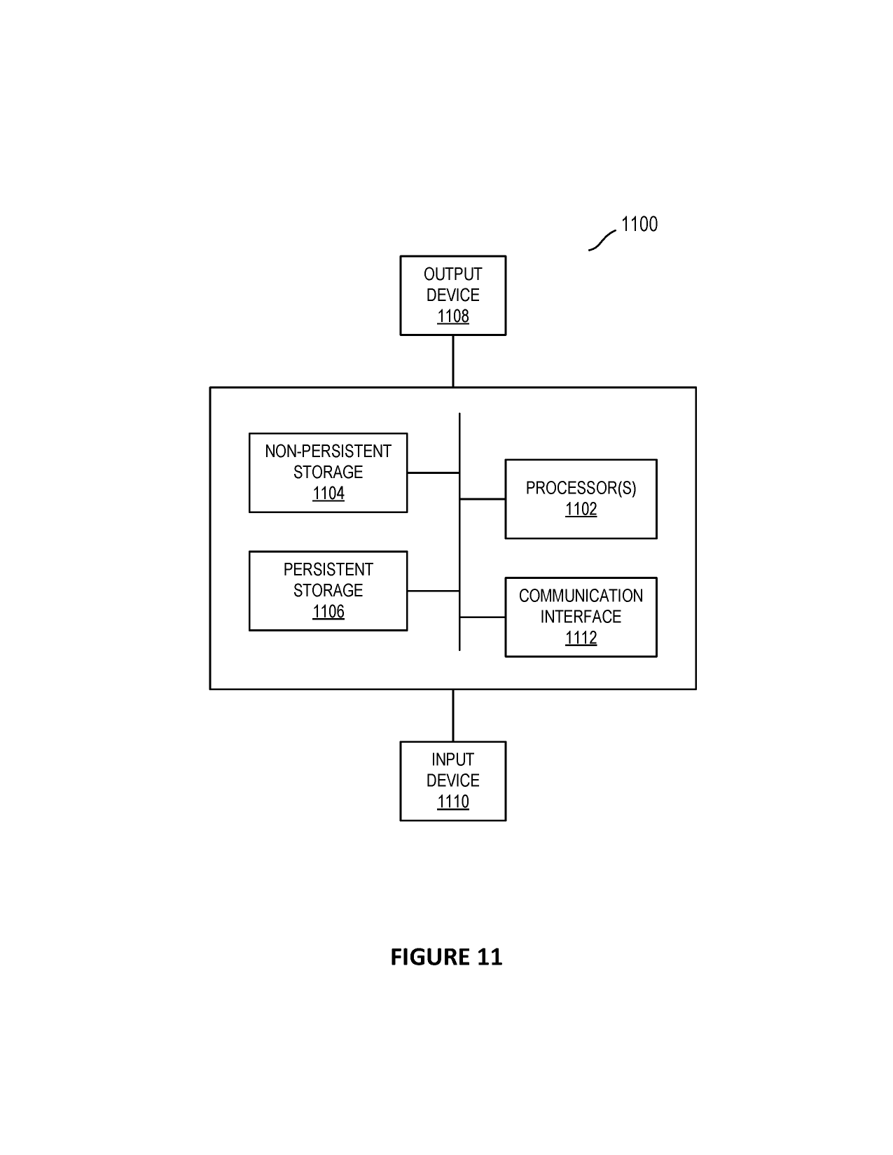

FIG. 11 illustrates a block diagram of an example computing device 1100, according to certain implementations. As discussed above, implementations of this disclosure may be implemented using computing devices. For example, all or any portion of the components or methods shown in FIGS. 1-10 (e.g., system 100, managed network 102, cloud network 104, IT infrastructure 108, virtualization manager 110, virtualization data collectors 114, data consumer service 118, collector coordination engine 122, computer system 200, signaling flow 300, and methods 600 through 1000) may be implemented, at least in part, using one or more computing devices such as computing device 1100.

Computing device 1100 may include one or more computer processors 1102, non-persistent storage 1104 (e.g., volatile memory, such as random access memory (RAM), cache memory, etc.), persistent storage 1106 (e.g., a hard disk, an optical drive such as a compact disk (CD) drive or digital versatile disk (DVD) drive, a flash memory, etc.), a communication interface 1112 (e.g., Bluetooth interface, infrared interface, network interface, optical interface, etc.), input devices 1110, output devices 1108, and numerous other elements and functionalities. Each of these components is described below.

In certain implementations, computer processor(s) 1102 may be an integrated circuit for processing instructions. For example, computer processor(s) may be one or more cores or micro-cores of a processor. Processor 1102 may be a general-purpose processor configured to execute program code included in software executing on computing device 1100. Processor 1102 may be a special purpose processor where certain instructions are incorporated into the processor design. Although only one processor 1102 is shown in FIG. 10, computing device 1100 may include any number of processors.

Computing device 1100 may also include one or more input devices 1110, such as a touchscreen, keyboard, mouse, microphone, touchpad, electronic pen, motion sensor, or any other type of input device. Input devices 1110 may allow a user to interact with computing device 1100. In certain implementations, computing device 1100 may include one or more output devices 1108, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) 1102, non-persistent storage 1104, and persistent storage 1106. Many different types of computing devices exist, and the aforementioned input and output device(s) may take other forms. In some instances, multimodal systems can allow a user to provide multiple types of input/output to communicate with computing device 1100.

Further, communication interface 1112 may facilitate connecting computing device 1100 to a network (e.g., a LAN, WAN) such as the Internet, mobile network, or any other type of network) and/or to another device, such as another computing device. Communication interface 1112 may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a Bluetooth® Low Energy (BLE) wireless signal transfer, an IBEACON® wireless signal transfer, a radio frequency identifier (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1112 may also include one or more Global Navigation Satellite System (GNSS) receivers or transceivers that are used to determine a location of the computing device 1100 based on receipt of one or more signals from one or more satellites associated with one or more GNSS systems. GNSS systems include, but are not limited to, the US-based global positioning system (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

All or any portion of the components of computing device 1100 may be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), CPUs, and/or other suitable electronic circuits), and/or can include and/or be implemented using computer software, firmware, or any combination thereof, to perform the various operations described herein. In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Certain implementations may provide none, some, or all of the following technical advantages. These and other potential technical advantages may be described elsewhere in this disclosure, or may otherwise be readily apparent to those skilled in the art based on this disclosure.

Certain implementations provide a centralized, potentially cloud-based, collector coordination engine to orchestrate multiple on-premises virtualization data collectors, which may provide for coordinated data collection across different products, services, and potentially even different customer environments, all managed from the cloud. Certain implementations may reduce or eliminate duplicate data collection by virtualization data collectors. For example, certain implementations may arrange for one virtualization collector to actively sends data for each virtualization management system, reducing or eliminating unnecessary data transfer and associated processing. Certain implementations may improve efficiency. For example, by reducing duplicate data collection and/or associated transmission, certain implementations may optimize network bandwidth usage and cloud storage resources. Certain implementations may provide centralized coordination. For example, the collector coordination engine, whether positioned in the cloud or on-premises, may provide a single point of control for managing multiple virtualization data collectors across different on-premises environments.

Certain implementations may enhance scalability, such as by accommodating any suitable number of virtualization data collectors and virtualization managers as an organization’s infrastructure grows. Certain implementations may provide automatic load balancing. For example, the collector coordination engine may distribute the collection workload across multiple virtualization data collectors, potentially assigning different virtualization data collectors to specific clusters within a virtualization environment. Certain implementations may provide a failover mechanism, which may increase availability. For example, if an active virtualization data collector becomes unavailable, certain implementations may automatically promote a standby virtualization data collector (e.g., a passive virtualization data collector) to active status, and promoting or ensuring continuous data collection.

Certain implementations may provide flexibility across virtualization solutions. For example, the collector coordination engine may operate with heterogeneous types of virtualization data collectors, such as those from different product lines or manufacturers, allowing for unified management across different solutions. Certain implementations may provide for simplified cloud-side data handling. For example, by eliminating duplicate data streams (e.g., from different virtualization data collectors) to cloud-based consumer services, certain implementations may simplify data processing and reconciliation tasks for cloud-based consumer services. Certain implementations may provide agnostic consumer services. For example, in certain implementations, cloud-based services can interact with the collector coordination engine without knowledge of the underlying virtualization data collector topology, which may simplify implementation. Certain implementations provide support for multi-datacenter and multi-virtualization manager environments. For example, the collector coordinator engine may manage virtualization data collectors across multiple physical locations and multiple virtualization management instances.

Certain implementations may reduce on-premises coordination complexity. For example, by moving coordination logic (e.g., collector coordination engine) to the cloud, certain implementations reduce or eliminate direct communication between on-premises virtualization data collectors, which may be separated by firewalls or other network boundaries. In certain implementations, one or more of these advantages may lead to a more efficient, scalable, and manageable data collection system for virtualized environments, potentially in complex enterprise scenarios with multiple products and services that use infrastructure data.

It should be understood that the systems and methods described in this disclosure may be combined in any suitable manner. Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer system, comprising:
one or more processors; and
one or more non-transitory computer-readable storage media storing programming for execution by the one or more processors, the programming comprising instructions to:
receive first registration information from a first virtualization data collector that is configured to collect first data from a first virtualization manager of a managed network;
receive second registration information from a second virtualization data collector that is configured to collect second data from the first virtualization manager, the first data and the second data being at least partially duplicative;
determine that the first virtualization data collector is to have a first active reporting status in which the first virtualization data collector is to transmit the first data to a data consumer service located in a cloud network;
configure, based on determining that the first virtualization data collector is to have the first active reporting status, the first virtualization data collector to have the first active reporting status; and
configure, based on determining that the first virtualization data collector is to have the first active reporting status, the second virtualization data collector to have a first standby reporting status in which the second virtualization data collector refrains from transmitting the second data to the data consumer service.

2. The computer system of claim 1, wherein the programming further comprises instructions to:
maintain a collector mapping that maps virtualization data collectors to one or more virtualization managers, the one or more virtualization managers comprising the first virtualization manager;
update, based on the first registration information, the collector mapping to include a first mapping between the first virtualization data collector and the first virtualization manager;
update, based on the second registration information, the collector mapping to include a second mapping between the second virtualization data collector and the first virtualization manager;
update, based on determining that the first virtualization data collector is to have the first active reporting status, the first mapping to reflect the first active reporting status of the first virtualization data collector; and
update, based on determining that the first virtualization data collector is to have the first active reporting status, the second mapping to reflect the first standby reporting status of the second virtualization data collector.

3. The computer system of claim 1, wherein:
the instructions to configure the first virtualization data collector to have the first active reporting status comprise instructions to cause a first reporting instruction to be transmitted to the first virtualization data collector to cause the first virtualization data collector have the first active reporting status; and
the instructions to configure the second virtualization data collector to have the first standby reporting status comprise instructions to cause a second reporting instruction to be transmitted to the second virtualization data collector to cause the second virtualization data collector to have the first standby reporting status.

4. The computer system of claim 1, wherein:
prior to receiving the second registration information, the first virtualization data collector has the first active reporting status;
the programming comprises instructions to determine, in response to receiving the second registration information, that the first virtualization already has the first active reporting status;
the instructions to determine that the first virtualization data collector is to have the first active reporting status comprise instructions to determine that the first virtualization data collector is to maintain the first active reporting status; and
the instructions to configure the first virtualization data collector to have the first active reporting status comprise instructions allowing the first virtualization data collector to maintain the first active reporting status.

5. The computer system of claim 1, wherein:
the first virtualization data collector is configured to collect third data from a second virtualization manager of the managed network;
the second virtualization data collector is configured to collect fourth data from the second virtualization manager of the managed network; and
the programming further comprises instructions to:
determine that the second virtualization data collector is to have a second active reporting status in which the second virtualization data collector is to transmit the fourth data to the data consumer service;
configure the second virtualization data collector to have the second active reporting status; and
configure the first virtualization data collector to have a second standby reporting status in which the first virtualization data collector refrains from transmitting the third data to the data consumer service.

6. The computer system of claim 5, wherein during at least partially overlapping time intervals:
the first virtualization data collector has the first active reporting status;
the second virtualization data collector has the first standby reporting status;
the second virtualization data collector has the second active reporting status; and
the first virtualization data collector has the second standby reporting status.

7. The computer system of claim 1, wherein:
the first virtualization manager manages a plurality of computing clusters of the managed network, plurality of computing clusters comprising a first computing cluster and a second computing cluster, the first data related to the first computing cluster;
the first virtualization data collector is configured to collect third data from the first virtualization manager, the third data related to the second computing cluster; and
the programming comprises instructions to configure, in response to determining that a third virtualization data collector is to have a second active reporting status in which the third virtualization data collector is to transmit fourth data related to the second computing cluster to the data consumer service, the first virtualization data collector to have a second standby reporting status in which the first virtualization data collector refrains from transmitting the third data to the data consumer service, the third data and the fourth data being at least partially duplicative.

8. The computer system of claim 1, wherein the programming further comprises instructions to:
receive third registration information from a third virtualization data collector that is configured to collect third data from the first virtualization manager, the third data being at least partially duplicative of the first data and the second data;
determine, in response to the third registration information, that the third virtualization data collector is to have a third active reporting status in which the third virtualization data collector is to transmit the third data to the data consumer service;
configure the third virtualization data collector to have the third active reporting status;
configure the first virtualization data collector to have a second standby reporting status in which the first virtualization data collector refrains from transmitting the first data to the data consumer service; and
configure the second virtualization data collector to maintain the first standby reporting status.

9. The computer system of claim 1, wherein the instructions to determine that the first virtualization data collector is to have the first active reporting status comprise instructions to determine, according to load balancing considerations, that the first virtualization data collector is to have the first active reporting status.

10. The computer system of claim 1, wherein the programming further comprises instructions to:
monitor operational statuses of the first virtualization data collector and the second virtualization data collector;
detect, at a time when the first virtualization data collector has the first active reporting status and the second virtualization has the first standby reporting status, an operational status of unavailable for the first virtualization data collector;
determine, in response to detecting the operational status of unavailable for the first virtualization data collector, that the second virtualization data collector is to have a second active reporting status in which the second virtualization data collector is to transmit the second data to the data consumer service; and
configure the second virtualization data collector to have the second active reporting status.

11. The computer system of claim 1, wherein:
the managed network is an on-premises computing environment that is remote from the computer system; and
the computer system is located in the cloud network.

12. A computer-implemented method, comprising:
receiving, by a computing device, registration information from a plurality of virtualization data collectors that are configured to collect first data from a first virtualization manager of a managed network for transmission to a data consumer service located in a cloud network, the plurality of virtualization data collectors being located in the managed network;
determining, by the computing device from among the plurality of virtualization data collectors, a particular virtualization data collector to transmit the first data to the data consumer service;
configuring, by the computing device, the particular virtualization data collector to transmit the first data to the data consumer service; and
configuring, by the computing device, other virtualization data collectors in the plurality of virtualization data collectors to refrain from transmitting the first data to the data consumer service.

13. The computer-implemented method of claim 12, wherein:
the method further comprises maintaining a collector mapping that maps the plurality of virtualization data collectors to one or more virtualization managers, the one or more virtualization managers comprising the first virtualization manager;
determining, from among the plurality of virtualization data collectors, the particular virtualization data collector to transmit the first data to the data consumer service comprises determining the particular virtualization data collector according to the collector mapping; and
the method further comprises updating, in response to determining the particular virtualization data collector to transmit the first data to the data consumer service, the collector mapping to include an active reporting status for the particular virtualization data collector in association with the first virtualization manager.

14. The computer-implemented method of claim 12, wherein:
configuring the particular virtualization data collector to transmit the first data to the data consumer service comprises transmitting a first reporting instruction to the particular virtualization data collector to cause the particular virtualization data collector to transmit the first data to the data consumer service; and
configuring other virtualization data collectors to refrain from transmitting the first data to the data consumer service comprises transmitting second reporting instructions to the other virtualization data collectors to cause the other virtualization data collectors to refrain from transmitting the first data to the data consumer service.

15. The computer-implemented method of claim 12, wherein:
the particular virtualization data collector is configured to transmit the first data to the data consumer service prior to receiving the registration information of at least one of the other virtualization data collectors; and
configuring the particular virtualization data collector to transmit the first data to the data consumer service after receiving the registration information for the at least one of the other virtualization data collectors comprises allowing the particular virtualization data collector to continue to transmit the first data to the data consumer service.

16. The computer-implemented method of claim 12, wherein:
the particular virtualization data collector and a second virtualization data collector of the plurality of virtualization data collectors are configured to collect second data from a second virtualization manager of the managed network; and
the method further comprises:
determining that the second virtualization data collector is to transmit the second data to the data consumer service;
configure the second virtualization data collector to transmit the second data to the data consumer service; and
configure the particular virtualization data collector to refrain from transmitting the second data to the data consumer service.

17. The computer-implemented method of claim 12, wherein:
the first virtualization manager manages a plurality of computing clusters of the managed network, plurality of computing clusters comprising a first computing cluster and a second computing cluster, the first data related to the first computing cluster;
the particular virtualization data collector is configured to collect second data from the first virtualization manager, the second data related to the second computing cluster; and
the method comprises configuring, in response to determining that a second virtualization data collector of the plurality of virtualization data collectors is to transmit the second data to the data consumer service, the particular virtualization data collector to refrain from transmitting the second data to the data consumer service.

18. The computer-implemented method of claim 12, wherein determining that the particular virtualization data collector is to transmit the first data to the data consumer service comprises determining, according to load balancing considerations, that the particular virtualization data collector is to transmit the first data to the data consumer service.

19. The computer-implemented method of claim 12, further comprising:
monitoring operational statuses of the plurality of virtualization data collectors;
detect, at a time when the particular virtualization data collector is configured to transmit the first data to the data consumer service, that the particular virtualization data collector has an operational status of unavailable;
determine, in response to detecting that the particular virtualization data collector has an operational status of unavailable, that a second virtualization data collector of the plurality of virtualization data collectors is to transmit the first data to the data consumer service; and
configuring the second virtualization data collector to transmit the first data to the data consumer service.

20. One or more non-transitory computer-readable storage media storing programming for execution by one or more processors, the programming comprising instructions to:
receive registration information from a plurality of virtualization data collectors that are configured to collect first data from a first virtualization manager of a managed network for transmission to a data consumer service located in a cloud network, the plurality of virtualization data collectors being located in the managed network;
determine, from among the plurality of virtualization data collectors, a particular virtualization data collector to transmit the first data to the data consumer service;
configure the particular virtualization data collector to transmit the first data to the data consumer service; and
configure other virtualization data collectors in the plurality of virtualization data collectors to refrain from transmitting the first data to the data consumer service.
